(19) United States
(12) Patent Application Publication
(10) Pub. No.: US 2024/0186494 A1
(43) Pub. Date: Jun. 6, 2024

(54) POSITIVE ELECTRODE FOR NON-AQUEOUS ELECTROLYTE SECONDARY BATTERY AND NON-AQUEOUS ELECTROLYTE SECONDARY BATTERY

(71) Applicant: THE FURUKAWA BATTERY CO., LTD., Yokohama-shi (JP)

(72) Inventors: Yuta KOBAYASHI, Fukushima (JP); Tomoya INOUE, Fukushima (JP); Yoshiya HAYASHI, Fukushima (JP)

(73) Assignee: THE FURUKAWA BATTERY CO., LTD., Yokohama-shi (JP)

(21) Appl. No.: 18/576,304

(22) PCT Filed: Aug. 30, 2022
(86) PCT No.: PCT/JP2022/032683

§ 371 Date: Jan. 3, 2024

(30) Foreign Application Priority Data
Aug. 31, 2021 (JP) 2021-141981
Sep. 8, 2021 (JP) 2021-146506
Sep. 8, 2021 (JP) 2021-146507
Sep. 8, 2021 (JP) 2021-146508
Mar. 31, 2022 (JP) 2022-057561

(51) Int. Cl. H01M 4/36; H01M 4/02; H01M 4/525; H01M 4/58; H01M 4/583; H01M 10/04; H01M 10/052

(52) U.S. Cl. CPC H01M 4/366; H01M 4/525; H01M 4/5825; H01M 4/583; H01M 10/0427; H01M 2004/021; H01M 2004/028; H01M 10/052

(57) ABSTRACT

Provided is a positive electrode for a non-aqueous electrolyte secondary battery. The positive electrode includes a positive electrode current collector and a positive electrode mixed material layer formed on a surface of the positive electrode current collector. The positive electrode mixed material layer includes: a first positive electrode active material that is a layered compound represented by a following general formula (1), LiₐNiₓCo_{y}M1_{1-x-y}O₂ (0<a≤1.2, 0<x≤0.9, 0<y≤0.5, 0<x+y<1) (1), a second positive electrode active material having a carbon material film formed on a surface of a phosphate compound that has an olivine structure and is represented by a following general formula (2), LiMn_{z}M2_{b}Fe_{1-z-b}PO₄ (0<z≤0.9, 0≤b≤0.1, 0<z+b<1) (2), and an electrically conductive agent. A median diameter of the first positive electrode active material is larger than D90 of the second positive electrode active material.

### FIELD

The present invention relates to a positive electrode for a non-aqueous electrolyte secondary battery and a non-aqueous electrolyte secondary battery.

### BACKGROUND

In a non-aqueous electrolyte secondary battery, ions in the electrolyte are responsible for an electrical conduction. A lithium secondary battery, one of the non-aqueous electrolyte secondary batteries, is installed as a power source in small electronic devices such as a digital camera and a notebook PC, as well as in a vehicle, among others. The lithium secondary battery consists of a positive electrode, a negative electrode, and a separator. The positive electrode has a positive electrode current collector and a positive electrode mixed material layer that is applied to the surface of the positive electrode current collector and contains a positive electrode active material, an electrically conductive agent, and a binding agent.

The positive electrode active material for the non-aqueous electrolyte secondary battery includes LiFePO₄ or an olivine compound having a part thereof replaced with Mn, LiCoO₂, LiNiO₂, LiMnO₂, LiCoNiO₂, LiCoMO₂, and LiNiMO₂, these compounds having a part thereof replaced with other elements, or a three-components layered compound containing Co, Ni, or Mn, among others. In particular, the layered compound has a high capacitance and a high voltage, making them suitable for the application where an energy density is considered to be important. However, because the layered compound is low in its heat stability in the state of being charged, when used in a non-aqueous electrolyte secondary battery, it is susceptible to heat generation due to a thermal runaway in the event of a short circuit; thus, this lacks a sufficient safety. Therefore, in order to secure the safety of the non-aqueous electrolyte secondary battery, the technology has been developed in which the layered compound is mixed with LiFePO₄ or an olivine compound having a part thereof replaced with Mn. Among them, the olivine compound having a part of LiFePO₄ replaced with Mn is known to be easier to secure the safety without significantly decreasing the energy density, because when this is mixed, the working voltage is not significantly different from that of the layered compound.

For example, in Patent Literature 1, in order to obtain a heat stability, in the positive electrode active material, an olivine compound, which accounts for 5 to 100% by volume fraction and has a particle diameter of about 0.1 to 3 μm, is mixed with a layered compound such as a lithium metal oxide. In Patent Literature 2, in the positive electrode active material, a layered compound is mixed with an olivine compound having a smaller average particle diameter than the layered compound.

In addition, in the Patent Literature 3, using LiNi_{5/10}Co_{2/10}Mn_{3/10}O₂ and an olivine compound as the positive electrode active materials, the condition to suppress the rise in the temperature of the battery surface during a short circuit is set based on the tapped density, the volume of the positive electrode active material, the rate of the void space in the positive electrode active material layer, and the positive electrode active material occupancy rate in the positive electrode active material layer calculated from these values. According to what is disclosed in Patent Literature 3, the lower the positive electrode active material occupancy rate, i.e., the higher the void rate in the substantial positive electrode active material layer, the easier it is to suppress the rise in the temperature of the battery surface during a short circuit.

### CITATION LIST

### Patent Literature

Patent Literature 1: Japanese Patent No. 6813487
Patent Literature 2: Japanese Patent No. 5574239
Patent Literature 3: Japanese Patent No. 6202191

### SUMMARY

### Technical Problem

### First Problem

However, from the study by the inventor of the present invention, it was found that these prior art technologies may not be sufficient in terms of the safety against an abrupt short circuit, the safety which is required recently for a non-aqueous electrolyte secondary battery. In particular, when a plurality of non-aqueous secondary electrolyte batteries are connected in parallel as a battery assembly, the resistance of the entire battery assembly decreases. Therefore, even with the same short-circuit, the short-circuit current tends to flow more rapidly than when the non-aqueous electrolyte secondary battery 1s used singly, so that a countermeasure for this have been sought. Specifically, when the temperature of the non-aqueous electrolyte secondary battery reaches the temperature high enough to surely cause meltdown of the separator, further short circuit occurs inside the secondary non-aqueous electrolyte battery, thereby leading to a chain heating. Therefore, it is required to develop the non-aqueous electrolyte secondary battery that can suppress a heat generation even when an abrupt short circuit occurs.

The present invention was made in the background mentioned above, and thus an object of the present invention is to provide a positive electrode for a non-aqueous electrolyte secondary battery and a non-aqueous electrolyte secondary battery that suppress a heat generation even when an abrupt short circuit occurs.

### Second Problem

In addition, in the Patent Literature 3, LiNi_{5/10}Co_{2/10}Mn_{3/10}O₂ and LiFePO₄ are used as the positive electrode active materials, but the study about the use of a layered compound and an olivine compound in which LiFePO₄ is partially replaced by Mn was insufficient. The layered compound and the olivine compound in which LiFePO₄ is partially replaced by Mn are close to each other in a reaction potential, and the reactivity with the electrolyte solution is different from that in the case in Patent Literature 3. Therefore, the inventor of the present application carried out an extensive investigation; as a result, it was found that the value of positive electrode active material occupancy rate specified in Patent Literature 3 did not exhibit the effect of suppressing the temperature rise at the time of a short circuit. In other words, a simple use of the technology in Patent Literature 3 could not always suppress the heat generation in the event of a short circuit.

The present invention was made in the background mentioned above, and thus an object of the present invention is to provide a positive electrode for a non-aqueous electrolyte secondary battery and a non-aqueous electrolyte secondary battery that suppress a heat generation during a short circuit.

### Solution to Problem

In order to solve the problem above and achieve the object, a positive electrode for a non-aqueous electrolyte secondary battery according to the present invention is a positive electrode for a non-aqueous electrolyte secondary battery, including a positive electrode current collector and a positive electrode mixed material layer formed on a surface of the positive electrode current collector. The positive electrode mixed material layer includes: a first positive electrode active material that is a layered compound represented by a following general formula (1), LiₐNiₓCo_{y}M1_{1-x-y}O₂ (0<a≤1.2, 0<x≤0.9, 0<y≤0.5, 0<x+y<1) (1), a second positive electrode active material having a carbon material film formed on a surface of a phosphate compound that is represented by a following general formula (2) and that has an olivine structure, and LiMn_{z}M2_{b}Fe_{1-z-b}PO₄ (0<z≤0.9, 0≤b≤0.1, 0<z+b<1) (2), an electrically conductive agent; and a median diameter of the first positive electrode active material is larger than D90 of the second positive electrode active material, in the above formula (1), M1 is at least one element selected from Ti, Zr, Nb, W, P, Al, Mg, V, Mn, Ca, Sr, Cr, Fe, B, Ga, In, Si, Mo, Y, Sn, Cu, Ag, Ce, Pr, Ge, Bi, Ba, Er, La, Sm, Yb, Sb, Bi, S and Zn, and in the above formula (2), M2 is at least one element selected from Ni, Co, Ti, Cu, Zn, Mg, Zr, Ca, Y, Mo, Ba, Pb, Bi, La, Ce, Nd, Gd, Al, Ga and Sr.

In the positive electrode for a non-aqueous electrolyte secondary battery according to the present invention, the second positive electrode active material has a tapped density of 0.70 g/cc or more and 1.00 g/cc or less.

In the positive electrode for a non-aqueous electrolyte secondary battery according to the present invention, a median diameter of the second positive electrode active material is 1/100 or more and ⅕ or less of the median diameter of the first positive electrode active material.

In the positive electrode for a non-aqueous electrolyte secondary battery according to the present invention, a median diameter of the second positive electrode active material is 0.1 μm or more and 1.0 μm or less.

In the positive electrode for a non-aqueous electrolyte secondary battery according to the present invention, a ratio of a weight of the second positive electrode active material to a total weight of the first positive electrode active material and the second positive electrode active material is 10% or more and 30% or less.

In the positive electrode for a non-aqueous electrolyte secondary battery according to the present invention, when a tapped density (g/cc) of the first positive electrode active material is represented by W1, a tapped density (g/cc) of the second positive electrode active material is represented by W2, a ratio of a weight of the first positive electrode active material to a total weight of the first positive electrode active material and the second positive electrode active material, upon considering the total weight as 1, is represented by R1, a ratio of a weight of the second positive electrode active material to the total weight of the first positive electrode active material and the second positive electrode active material, upon considering the total weight as 1, is represented by R2, and a density (g/cc) of the positive electrode mixed material layer calculated based on a thickness of the positive electrode for a non-aqueous electrolyte secondary battery when a charging rate of the non-aqueous electrolyte secondary battery after initial activation is 0% is represented by D, a following formula (3) is satisfied.

0.760≤(W1×R1+W2×R2)/D≤0.960 (3)

In the positive electrode for a non-aqueous electrolyte secondary battery according to the present invention, the weight ratio R2 is 0.1 or more and 0.3 or less.

In the positive electrode for a non-aqueous electrolyte secondary battery according to the present invention, a ratio of a specific surface area of the first positive electrode active material to a specific surface area of the second positive electrode active material is 0.005 or more and 0.025 or less.

A non-aqueous electrolyte secondary battery according to the present invention includes: the positive electrode for a non-aqueous electrolyte secondary battery according to the present invention; a negative electrode; a separator; and a non-aqueous electrolyte including a lithium salt and a non-aqueous solvent.

### Advantageous Effects of Invention

According to the present invention, it is possible to obtain a positive electrode for a non-aqueous electrolyte secondary battery and a non-aqueous electrolyte secondary battery that can suppress a heat generation due to a thermal runaway even in the case of an abrupt short circuit.

According to the present invention, it is possible to obtain a positive electrode for a non-aqueous electrolyte secondary battery and a non-aqueous electrolyte secondary battery that suppress a heat generation during a short circuit.

### BRIEF DESCRIPTION OF DRAWINGS

FIG. 1 is a cross-sectional view of a non-aqueous electrolyte secondary battery equipped with a positive electrode for a non-aqueous electrolyte secondary battery according to a first embodiment of the present invention to explain the configuration thereof.

FIG. 2 is a perspective view of a disassembled non-aqueous electrolyte secondary battery equipped with a positive electrode for a non-aqueous electrolyte secondary battery according to a fifth embodiment of the present invention to explain the configuration thereof.

### DESCRIPTION OF EMBODIMENTS

Hereinafter, embodiments of the present invention will be described, but the present invention is not limited to the description below. Various modifications or improvements can be made to these embodiments, and the embodiments with such modifications or improvements may also be included in the present invention.

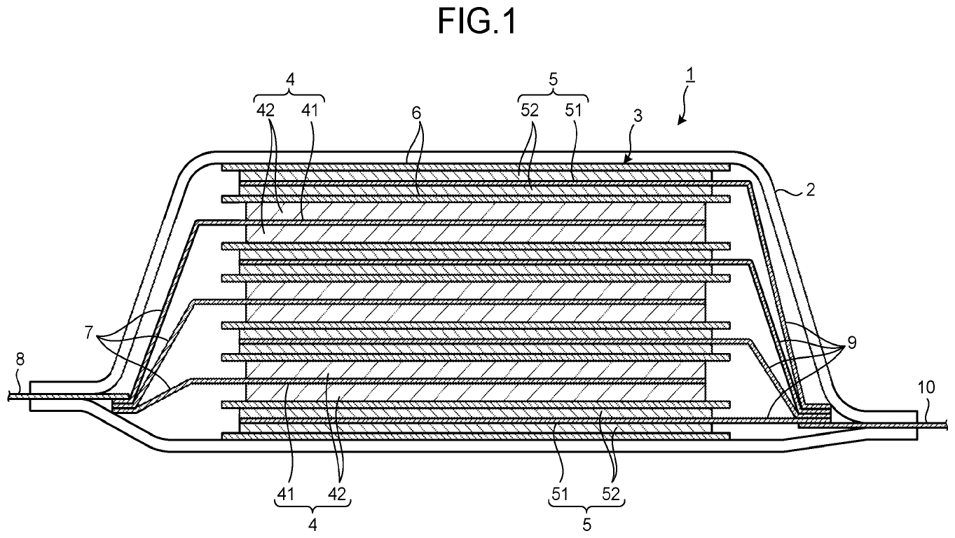

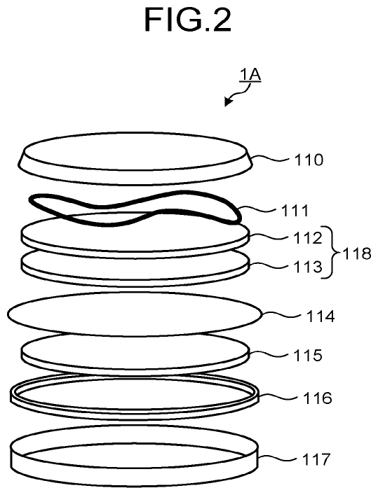

As it is going to be described in detail later, FIG. 1 illustrates a cross-sectional view of a laminate-type non-aqueous electrolyte secondary battery, and FIG. 2 illustrates a perspective view of a disassembled coin-type non-aqueous electrolyte secondary battery.

Although FIGS. 1 and 2 show configuration examples for laminate- and coin-type non-aqueous electrolyte secondary batteries as an example of the embodiments, the shape of the non-aqueous electrolyte secondary battery 1n the present invention is not particularly restricted; so this may be a flat type, a cylindrical type, a square type, a coin type, or the like. The outer body of the non-aqueous electrolyte secondary battery 1s also not restricted and may be formed of a laminate film, an aluminum, an aluminum alloy, a stainless steel, or any other known material.

### First Embodiment

FIG. 1 is a cross-sectional view of a non-aqueous electrolyte secondary battery equipped with a positive electrode for a non-aqueous electrolyte secondary battery according to a first embodiment of the present invention to explain the configuration thereof. A non-aqueous electrolyte secondary battery 1 illustrated in FIG. 1 is a stacked non-aqueous electrolyte secondary battery consisting of a positive electrode, a negative electrode, and a separator as a set, in which a plurality of the sets is stacked together.

The non-aqueous electrolyte secondary battery 1 is equipped with a bag-like outer body 2 made of a laminate film. An electrode group 3 in a stacked structure is accommodated in the outer body 2. The laminate film has, for example, a structure in which metal foil such as aluminum foil is sandwiched between the adjacent plastic films that are formed by stacking a plurality of plastic films (e.g., two). One of the two plastic films is a thermally bondable resin film. In the outer body 2, two laminate films are stacked so that the thermally bondable resin films may face each other, and the electrode group 3 and the non-aqueous electrolyte are accommodated between these laminate films, and the two laminate film portions around the electrode group 3 are sealed by thermally bonding with each other, hermetically sealing the electrode group 3 and the non-aqueous electrolyte.

The electrode group 3 has a positive electrode 4, a negative electrode 5, a separator 6, a positive electrode lead 7, a positive electrode tab 8, a negative electrode lead 9, and a negative electrode tab 10. The separator 6 is interposed between the positive electrode 4 and the negative electrode 5. The electrode group 3 has a multiple stacked structure formed such that the negative electrode 5 is located at the outermost layer and the separator 6 is located between the negative electrode 5 and the inner surface of the outer body 2.

The positive electrode 4 consists of a positive electrode current collector 41 and a positive electrode mixed material layer 42 formed on one or both sides of the positive electrode current collector 41.

The positive electrode current collector 41 is formed of aluminum, nickel, stainless steel, titanium, alloy, or the like. Aluminum is especially preferable in view of an electronic conductivity and a battery operating potential.

The positive electrode mixed material layer 42 includes a first positive electrode active material and a second positive electrode active material, an electrically conductive agent, and a binding agent.

The first and second positive electrode active materials both are capable of absorbing and desorbing lithium.

The first positive electrode active material is a layered compound represented by the general formula (1) below. The layered compound is a composite metal oxide containing lithium (Li), nickel (Ni), and cobalt (Co), having a structure in which the layer is formed by sheet-like particles.

LiₐNiₓCo_{y}M1_{1-x-y}O₂ (1)

Here, in the formula (1), M1 is at least one element selected from titanium (Ti), zirconium (Zr), niobium (Nb), tungsten (W), phosphorous (P), aluminum (Al), magnesium (Mg), vanadium (V), manganese (Mn), calcium (Ca), strontium (Sr), chromium (Cr), iron (Fe), boron (B), gallium (Ga), indium (In), silicon (Si), molybdenum (Mo), yttrium (Y), tin (Sn), copper (Cu), silver (Ag), cerium (Ce), praseodymium (Pr), germanium (Ge), bismuth (Bi), barium (Ba), erbium (Er), lanthanum (La), samarium (Sm), ytterbium (Yb), antimony (Sb), bismuth (Bi), sulfur (S), and zinc (Zn), where 0<a≤1.2, 0<x≤0.9, 0<y≤0.5, and 0<x+y<1.

The second positive electrode active material is a compound having a film formed of a carbon material on the surface of a phosphate compound (olivine compound) that is represented by the general formula (2) below and that has an olivine structure.

LiMn_{z}M2_{b}Fe_{1-z-b}PO₄ (2)

Here, in the general formula (2), M2 is at least one element selected from nickel (Ni), cobalt (Co), titanium (Ti), copper (Cu), zinc (Zn), magnesium (Mg), zirconium (Zr), calcium (Ca), yttrium (Y), molybdenum (Mo), barium (Ba), lead (Pb), bismuth (Bi), lanthanum (La), cerium (Ce), neodymium (Nd), gadolinium (Gd), aluminum (Al), gallium (Ga), and strontium (Sr), where 0<z≤0.9, 0≤b≤0.1, and 0<z+b<1.

The carbon material is a carbon material having electrical conductivity. In the second positive electrode active material, at least a part of the surface of the primary particle thereof is at least partially covered with the carbon material film that is present on the surface of the second positive electrode active material. Although the purity of the carbon and the thickness of the carbon film may be selected arbitrarily, it is preferable to control the ratio of the weight of the carbon material to the weight of the entire second positive electrode active material to 0.1% or more and 5% or less.

It is preferable that a tapped density of the second positive electrode active material is 0.7 g/cc or more and 1.00 g/cc or less, and more preferably 0.8 g/cc or more. When the tapped density is 1.00 g/cc or less, the primary particles of the second positive electrode active material do not form dense granulates or secondary particles, so that the second positive electrode active material can surround the first positive electrode active material with less void spaces compared to conventional materials; thus, in the event of a short circuit, it is presumed that an exothermic reaction caused by the direct contact of the first positive electrode active material with the non-aqueous electrolyte can be suppressed. As a result, a heat generation due to the thermal runaway at the time of a short circuit can be suppressed. On the other hand, when the tapped density is greater than 1.00 g/cc, the second positive electrode active material is considered to be less likely to surround the first positive electrode active material because the second positive electrode active material is densely granulated, so that the temperature rise of the non-aqueous electrolyte secondary battery during a short circuit cannot be prevented, thereby readily resulting in swelling, rupturing, and bursting. When the tapped density is less than 0.70 g/cc, the dispersibility of the second positive electrode active material during preparation of a slurry of the positive electrode mixed material layer 42 decreases thereby readily forming the lumps to induce threading during formation of the positive electrode, which makes difficult to form the positive electrode having a uniform quality. When the tapped density is 0.80 g/cc or more, the dispersibility of the second positive electrode active material during preparation of the slurry is much better.

The median diameter of the second positive electrode active material is preferably 1/100 or more and ⅕ or less of the median diameter of the first positive electrode active material. The median diameter of the second positive electrode active material is preferably 0.1 μm or more and 1.0 μm or less. When these requirements are satisfied, it is considered that the second positive electrode active material can surround the first positive electrode active material with less void spaces compared to the conventional one, and because of this, the heat generation due to thermal runaway at the time of a short circuit can be suppressed more readily. Therefore, not only the temperature rise of the non-aqueous electrolyte secondary battery 1s less likely to occur during a short circuit, but also swelling, rupturing, bursting, or the like due to decomposition of the electrolyte caused by the temperature rise are less likely to occur on the surface of the first positive electrode active material. When the median diameter of the second positive electrode active material is extremely smaller as compared to that of the first positive electrode active material, the dispersibility of the second positive electrode active material during preparation of the slurry of the positive electrode mixed material layer 42 decreases thereby readily forming the lumps to induce threading during formation of the positive electrode, which makes difficult to form the positive electrode having a uniform quality. When the median diameter of the second positive electrode active material is attempted to make less than 0.1 μm, the crystallinity of the second positive electrode active material itself tends to be extremely low, making the material synthesis itself difficult. When the median diameter of the second positive electrode active material is 1/20 or more of the median diameter of the first positive electrode active material, or the median diameter of the second positive electrode active material is 0.5 μm or more, the dispersibility of the second positive electrode active material during preparation of the slurry is much better. The median diameter is sometimes referred to as D50 in this specification.

In the positive electrode mixed material layer 42, the median diameter of the first positive electrode active material is larger than D90 of the second positive electrode active material. When the median diameter of the first positive electrode active material is smaller than D90 of the second positive electrode active material, as measured by a laser diffraction and scattering method, the proportion of the second positive electrode active material having a larger particle diameter than the first positive electrode active material will increase, so that the second positive electrode active material cannot surround the first positive electrode active material without void spaces. As a result, the area where the first positive electrode active material is in contact with the electrolyte increases, which makes easier for the thermal runaway to take place in the event of a short circuit, resulting in the increase in the amount of heat generation in the cell.

Conventional technologies, including those in Patent Literature 2, have been focusing mainly on the median diameter of the first positive electrode active material and of the second positive electrode active material. However, by definition of the median diameter, actually, 50% of the second positive electrode active material has the particle diameter greater than the median diameter; thus, simply focusing on the median diameter alone, there is a possibility that many second positive electrode active materials having the particle diameters greater than the first positive electrode active material can exist. However, because the present invention focuses on D90 of the second positive electrode active material, it is possible to ensure the state that the majority of the second positive electrode active material has a smaller particle diameter than the first positive electrode active material, thereby enabling to achieve the structure in which the second positive electrode active material surrounds the first positive electrode active material without void spaces as described above.

Although the above mentioned median diameter, D90, and the tapped density refer to the values in the positive electrode mixed material layer 42 after fabrication of the non-aqueous electrolyte secondary battery, they are almost equal to the values of the median diameter, D90, and the tapped density of the first positive electrode active material and the second positive electrode active material before forming the positive electrode. Therefore, when the values of the median diameter, D90, and the tapped density of the first positive electrode active material and the second positive electrode active material before formation satisfy the requirements of the present invention, the formed positive electrode can also be considered to satisfy the requirements of the present invention.

Whether or not the values of the median diameter, D90, and the tapped density of the first positive electrode active material and the second positive electrode active material in the positive electrode mixed material layer after formation satisfy the requirements of the invention, and the ratio of the weight of the second positive electrode active material to the total weight of the first positive electrode active material and the second positive electrode active material can be checked, for example, by the following method. The non-aqueous electrolyte secondary battery 1s disassembled in an argon-filled glove box, and the positive electrode 4 is taken out. The positive electrode 4 is washed with an appropriate solvent (e.g., dimethyl carbonate) and then vacuum dried to remove the solvent. Next, the positive electrode is immersed in a solvent such as N-methyl-2-pyrrolidone followed by sonication with an ultrasonic wave to separate the positive electrode mixed material layer 42 from the positive electrode current collector 41. The solvent in which the positive electrode mixed material layer 42 thus separated is dispersed is subjected to centrifugal separation to separate each material in the positive electrode mixed material layer 42. For the separated first and second positive electrode active materials, the median diameter and D90 can be measured, for example, by a laser diffraction and scattering method, and the tapped density can be measured, for example, by placing them in a vessel followed by tapping the vessel and then measuring the weight divided by the volume whose void spaces among the particles are filled. The ratio of the weight of the second positive electrode active material to the total weight can be calculated from the weights of the separated first and second positive electrode active materials. In the non-aqueous electrolyte secondary battery used above, the initial activation or the charge-discharge cycle may be carried out at any process. When the positive electrode 4 is taken out, this is carried out preferably in the state of previously being fully discharged to the lower limit voltage assumed by the manufacturer.

The ratio of the weight of the second positive electrode active material to the total weight of the first positive electrode active material and the second positive electrode active material is preferably 10% or more and 30% or less. When the weight ratio of the second positive electrode active material is more than 30%, the charge-discharge curve of the non-aqueous electrolyte secondary battery 1 tends to become a multi-staged curve (inflection point increases), making it difficult to estimate the charging depth and the deterioration state from the voltage and current values during charge-discharge, thereby lowering the practicality thereof. When the weight ratio of the second positive electrode active material is less than 10%, it would be difficult for the second positive electrode active material to sufficiently surround the first positive electrode active material. Insufficient coverage of the first positive electrode active material by the second positive electrode active material causes decomposition of the electrolyte on the surface of the first positive electrode active material, which can readily cause the thermal runaway during a short circuit.

The electrically conductive agent aids the conduction of electrons at the positive electrode. There is no particular restriction in the conducting agent; so any known electrically conductive agent may be used. Illustrative examples of the electrically conductive agent include electrically conductive carbon powders such as carbon black such as acetylene black and Ketjen black, as well as carbon nanotubes, carbon nanofibers, graphene, activated carbon, and graphite. The electrically conductive agent may consist of one material or a plurality of materials (e.g., a first electrically conductive agent and a second electrically conductive agent).

The binding agent binds together the positive electrode current collector, the positive electrode active material, and the electrically conductive agent. There is no particularly restricted in the binding agent; known or commercially available agents may be used. Illustrative examples of the binding agent include polyvinylidene fluoride (PolyVinylidene Difluoride: PVDF), PolyTetraFluoroEthylene (PTFE), PolyVinyl Pyrrolidone (PVP), PolyVinyl Chloride (PVC), PolyEthylene (PE), PolyPropylene (PP), ethylene-propylene copolymer, Styrene-Butadiene Rubber (SBR), butadiene rubber, PolyVinyl Alcohol (PVA), CarboxyMethyl Cellulose (CMC), butyl rubber, poly(meth)acrylate (PolyMethyl MethAcrylate: PMMA), PolyEthylene Oxide (PEO), Polypropylene Oxide (PO), polyepichlorohydrin (Epichlorohydrin), Polyphosphazene, Polyacrylonitrile, hexafluopropylene (HFP), as well as one of these copolymers or a mixture of two or more of them.

The negative electrode 5 consists of a negative electrode current collector 51 and a negative electrode mixed material layer 52 containing the negative electrode active material or metal lithium (not illustrated) formed on one or both sides of the negative electrode current collector 51.

There is no particular restriction in the negative electrode current collector 51; but a metal is preferable. The metal like this is preferably, for example, aluminum foil or copper; depending on the use, a porous aluminum current collector or the like is also used. In particular, copper is particularly preferable from the viewpoint of the electronic conductivity and the battery operating potential.

The negative electrode mixed material layer 52 contains at least one or more active materials selected from, for example, lithium, a lithium alloy, a titanium niobium alloy, or graphite, amorphous carbon, transition metal composite oxides (such as Li₄Ti₅O₁₂, or TiNb₂O₇), or an alloy that can absorb and desorb lithium, or silicon. Among these, graphite is preferable because this has an operating potential very close to that of metal lithium and excellent cycle characteristics, and also charging and discharging can be performed at a high operating voltage. A combination of graphite with other negative electrode active material may also be used. The negative electrode mixed material layer 52 contains an electrically conductive agent and a binding agent. The electrically conductive agent and the binding agent may be materials equivalent to those used in the positive electrode 4.

The separator 6 is installed between the positive electrode and the negative electrode and is porous so as to allow passage of the non-aqueous electrolyte components. The separator 6 is formed, for example, with a porous sheet separator made of a polymer or a fiber, a non-woven separator, or the like. The separator 6 may be made of polyethylene, polypropylene, aramid, polyimide, or other materials, and may have multiple layers of different materials including these, but in view of providing a shutdown function during heat generation, it is preferable to have a layer containing polyethylene. The pore diameter of the separator 6 is preferably in the range of 0.01 and 10 μm and the thickness thereof is preferably in the range of 5 and 30 μm. The separator 6 may be made of a ceramic layer as a heat-resistant insulating layer that is laminated onto a porous substrate. When a solid electrolyte is used for the non-aqueous electrolyte, the separator 6 may not be present.

The positive electrode leads 7 each extend, for example, to the lower side of the positive electrode mixed material layer 42 as illustrated in FIG. 1. As one example, each positive electrode lead 7 is a portion of the positive electrode current collector 41 uncoated with the positive electrode mixed material layer 42. The positive electrode leads 7 each are bundled at the end in the opposite side of the positive electrode mixed material layer 42 in the outer body 2, and they are bonded with each other.

One end of the positive electrode tab 8 is bonded to the positive electrode leads 7 and the other end thereof extends outside of the outer body 2 through the sealing portion.

The negative electrode leads 9 each extend, for example, to the upper side of the negative electrode mixed material layer 52, as illustrated in FIG. 1. It may extend in the same direction as the positive electrode lead 7 as long as it does not contact with the positive electrode lead 7. As one example, each negative electrode lead 9 is a portion of the negative electrode current collector 51 uncoated with the negative electrode mixed material layer 52. The negative electrode leads 9 each are bundled at the end in the opposite side of the negative electrode mixed material layer 52 in the outer body 2, and they are bonded with each other.

One end of the negative electrode tab 10 is bonded to the negative electrode leads 9 and the other end thereof extends outside of the outer body 2 through the sealing portion.

A non-aqueous electrolyte solution or a solid electrolyte may be used as the non-aqueous electrolyte. Hereinafter, in particular, the non-aqueous electrolyte solution will be described. The non-aqueous electrolyte solution is sealed into the outer body 2. The charging point of the non-aqueous electrolyte solution in the outer body 2 is sealed after the non-aqueous electrolyte solution is charged. The non-aqueous electrolyte solution contains an electrolyte and a non-aqueous solvent.

There is no particular restriction in the electrolyte; a lithium salt generally used in the non-aqueous electrolyte secondary batteries may be used. Illustrative examples that are useful include LiPF₆, LiAsF₆, LiBF₄, LiCF₃SO₃, LiN(CₘF₂ₘ₊₁SO₂) (CₙF₂ₙ₊₁SO₂) (m and n are integers of 1 or more), LiC (CₚF₂ₚ₊₁SO₂) (C_{q}F₂ₚ₊₁SO₂) (CrF₂ᵣ₊₁SO₂) (p, q, and r each are integers of 1 or more), lithium difluoro(oxalato)borate, and lithium bisoxalate borate. These electrolytes may be used singly or in a combination of two or more of them. In view of the lithium ion conductivity, the viscosity of the electrolyte solution, the temperature characteristics of conductivity, and the like, the concentration of the electrolyte is in the range of 0.1 and 3 mol/L, and preferably in the range of 0.5 and 1.5 mol/L.

The non-aqueous solvent contains a cyclic carbonate and/or a chain carbonate as the major component therein. The cyclic carbonate is preferably at least one carbonate selected from Ethylene Carbonate (EC), Propylene Carbonate (PC), and Butylene Carbonate (BC). The chain carbonate is preferably at least one carbonate selected from DiMethyl Carbonate (DMC), DiEthyl Carbonate (DEC), and Ethyl Methyl Carbonate (EMC), and other chain carbonates. The cyclic carbonate is related to the degree of dissociation of the electrolyte components, while the chain carbonate is related to the viscosity of the electrolyte solution.

An additive other than the lithium salts described above may be included for the purpose of forming a high-quality film on the surface of the negative electrode active material by reductive decomposition during charging/discharging. There is no particular restriction in the additive; illustrative examples thereof include vinylene carbonate, fluoroethylene carbonate, 1,3,2-dioxathiolane 2,2-dioxide (MMDS), 1,5,2,4-dioxadithiane 2,2,4,4-tetraoxide, tris(trimethylsilyl) phosphite, 1-propene 1,3-sultone, and Li₂PO₂F₂. These additives may be used singly or in a mixture of two or more of them. It may also be mixed with other additives. In addition, these other additives may be used singly.

In the first embodiment, in the positive electrode 4 of the non-aqueous electrolyte secondary battery 1, the positive electrode mixed material layer 42 is made to have the first positive electrode active material represented by the general formula (1) and the second positive electrode active material including a compound represented by the general formula (2), and the median diameter of the first positive electrode active material is made to be greater than D90 of the second positive electrode active material. In the positive electrode mixed material layer 42, satisfying the above conditions ensures the state that the majority of the second positive electrode active material is smaller than the first positive electrode active material, and that the second positive electrode active material covers the first positive electrode active material more securely, thereby suppressing the decomposition of the electrolyte solution on the surface of the first positive electrode active material, which in turn suppresses the thermal runaway during a short circuit. According to the first embodiment, it is possible to obtain the positive electrode 4 and the non-aqueous electrolyte secondary battery 1 that suppress the heat generation even when an abrupt short circuit occurs.

### Second Embodiment

Next, a second embodiment of the present invention will be described. The non-aqueous electrolyte secondary battery according to the second embodiment has the same composition elements as the non-aqueous electrolyte secondary battery 1 according to the first embodiment (see FIG. 1). Hereinafter, explanation will be made as to the parts that are different from the first embodiment.

Similarly to the first embodiment, the positive electrode 4 consists of the positive electrode current collector 41 and the positive electrode mixed material layer 42 formed on one or both sides of the positive electrode current collector 41. The positive electrode mixed material layer 42 includes the first positive electrode active material and the second positive electrode active material, the electrically conductive agent, and the binding agent.

In the second embodiment, in the positive electrode 4 of the non-aqueous electrolyte secondary battery 1, the positive electrode mixed material layer 42 has the first positive electrode active material represented by the general formula (1) and the second positive electrode active material containing a compound represented by the general formula (2). Similarly to the first embodiment, the median diameter of the first positive electrode active material is preferably larger than D90 of the second positive electrode active material, and the tapped density of the second positive electrode active material is preferably 0.7 g/cc or more and 1.00 g/cc or less, and more preferably 0.8 g/cc or more.

Here, because the positive electrode mixed material layer 42 includes the second positive electrode active material represented by the general formula (2), the structure is formed in which the first positive electrode active material having a low thermal stability is surrounded by the second positive electrode active material having a high thermal stability; thus, in the event of a short circuit, the exothermic reaction caused by the direct contact of the first positive electrode active material with the non-aqueous electrolyte can be reduced.

When the tapped density of the first positive electrode active material (g/cc) is represented by W1, the tapped density of the second positive electrode active material (g/cc) is represented by W2, the ratio of the weight of the first positive electrode active material upon taking the total weight of the first and second positive electrode active materials as 1 is represented by R1, the ratio of the weight of the second positive electrode active material upon taking the total weight of the first and second positive electrode active materials as 1 is represented by R2, and the density (g/cc) of the positive electrode mixed material layer 42 is represented by D, the following formula (3) is satisfied.

0.760≤(W1×R1+W2×R2)/D≤0.960 (3)

The density D of the positive electrode mixed material layer 42 here refers to the value calculated based on the thickness of the positive electrode when the State Of Charge (SOC) of the non-aqueous electrolyte secondary battery after the initial activation process with at least one cycle of the charge/discharge is 0%.

In the above formula (3), the value of (W1×R1+W2×R2)/D is the ratio of the density of the positive electrode mixed material layer to the weight average of the tapped densities of the positive electrode active materials, representing the degree of the void space in the substantial positive electrode mixed material layer. When the value of the above formula is less than 0.760, the positive electrode mixed material layer becomes too dense, which may cause distortion of the electrode during the pressing process at the time of the electrode formation, so that there are some cases that the fabrication efficiency in the battery fabrication is lowered. When the value of the above formula is more than 0.960, the degree of the void space in the substantial positive electrode mixed material layer increases, so that the area of the direct contact between the first positive electrode active material and the non-aqueous electrolyte increases even when the positive electrode mixed material layer 42 contains the second positive electrode active material. As a result, the first positive electrode active material having a low thermal stability and the non-aqueous electrolyte are more likely to cause an exothermic reaction when the non-aqueous electrolyte secondary battery 1s short-circuited; thus, the heat generation of the non-aqueous electrolyte secondary battery cannot be suppressed. In other words, by making the value of the above formula (3) to 0.760 or more and 0.960 or less, the degree of the void space in the substantial positive electrode mixed material layer can be lowered while keeping the forming efficiency at the pressing process during the electrode formation; thus, the exothermic reaction between the first positive electrode active material and the non-aqueous electrolyte during a short circuit can be suppressed as much as possible, thereby enabling to suppress the heat generation of the non-aqueous electrolyte secondary battery.

R2, the weight ratio of the second positive electrode active material, is preferably 0.1 or more and 0.3 or less. When the weight ratio of the second positive electrode active material is more than 0.3 (30%), the charge-discharge curve of the non-aqueous electrolyte secondary battery 1 tends to become a multi-staged curve (inflection point increases), making it difficult to estimate the charging depth and the deterioration state from the voltage and current values during charging and discharging, thereby lowering the practicality thereof. When the weight ratio of the second positive electrode active material is less than 0.1 (10%), the coating of the first positive electrode active material by the second positive electrode active material can be insufficient. Insufficient coverage of the first positive electrode active material by the second positive electrode active material causes decomposition of the electrolyte on the surface of the first positive electrode active material, which can readily cause the thermal runaway during a short circuit.

In the second embodiment, in the positive electrode 4 of the non-aqueous electrolyte secondary battery 1, when the tapped density of the first positive electrode active material is represented by W1, the tapped density of the second positive electrode active material is represented by W2, the ratio of the weight of the first positive electrode active material upon taking the total weight of the first and second positive electrode active materials as 1 is represented by R1, the ratio of the weight of the second positive electrode active material upon taking the total weight of the first and second positive electrode active materials as 1 is represented by R2, and the density of the positive electrode mixed material layer 42 is represented by D, the positive electrode mixed material layer 42 was made to satisfy a value of (W1×R1+W2×R2)/D of 0.760 or more and 0.960 or less. Here, as described above, when LiNi_{5/10}Co_{2/10}Mn_{3/10}O₂ and LiMn_{0.7}Fe_{0.3}PO₄, which have close reaction potentials with each other, are mixed, the reactivity with the electrolyte solution can be increased by reducing the reaction area. Therefore, in the second embodiment, the density of the positive electrode 4 is made higher as compared to the overall density of the active materials, which is obtained from the weight average of the tapped densities of each active material. In other words, by reducing the substantial void space in the positive electrode 4, the contact area with the electrolyte solution is reduced, so that the abrupt heat generation due to thermal decomposition of the positive electrode 4 can be suppressed. According to the second embodiment, it is possible to obtain the positive electrode 4 and the non-aqueous electrolyte secondary battery 1 that suppress the heat generation in the event of a short circuit.

### Third Embodiment

Next, a third embodiment of the present invention will be described. The non-aqueous electrolyte secondary battery according to the third embodiment has the same composition elements as the non-aqueous electrolyte secondary battery 1 according to the first embodiment (see FIG. 1). Hereinafter, explanation will be made as to the parts that are different from the first embodiment.

Similarly to the first embodiment, the positive electrode 4 consists of the positive electrode current collector 41 and the positive electrode mixed material layer 42 formed on one or both sides of the positive electrode current collector 41. The positive electrode mixed material layer 42 includes the first positive electrode active material and the second positive electrode active material, the electrically conductive agent, and the binding agent.

In the third embodiment, in the positive electrode 4 of the non-aqueous electrolyte secondary battery 1, the positive electrode mixed material layer 42 has the first positive electrode active material represented by the general formula (1) and the second positive electrode active material containing a compound represented by the general formula (2). Similarly to the first embodiment, it is preferable that the weight ratio of the second positive electrode active material to the total weight of the first positive electrode active material and the second positive electrode active material is preferably 10% or more and 30% or less, and that the tapped density of the second positive electrode active material is preferably 0.7 g/cc or more and 1.00 g/cc or less, and more preferably 0.8 g/cc or more.

Herein, in the X-ray diffraction pattern obtained by the X-ray diffraction measurement using a Cu-Kα radiation, the positive electrode 4 satisfies the P1/P2 ratio of 0.30 or more and 1.00 or less, where P1 represents a half width of the peak attributable to the (003) plane of the first positive electrode active material that exists between 18.0° or more and 19.0° or less in a diffraction angle (2θ) formed by the incident X-ray direction and the diffracted X-ray direction, and P2 represents a half width of the peak attributable to the (101) plane of the second positive electrode active material that exists between 20.0° or more and 21.0° or less in a diffraction angle (2θ). P1 and P2 are known to be inversely proportional to the crystallite diameter (primary particle diameter) of the first positive electrode active material and of the second positive electrode active material, respectively. The reason for focusing on the peaks attributable to the (003) plane of the first positive electrode active material and the (101) plane of the second positive electrode active material in the present invention is that their peak intensities are higher than other peaks due to their crystal structure (layered structure and olivine structure), and they are difficult to be mixed with other peaks in the vicinity, making it easy to accurately measure their half widths. Regardless of the types of positive electrode active materials, it is likely that the smaller the crystallite diameter, the higher the lithium ion diffusivity within the active material particles. Therefore, this means it is likely that the larger the ratio P1/P2, the higher the diffusivity of the lithium ion in the first positive electrode active material than the second positive electrode active material. When the ratio P1/P2 is more than 1.00, the diffusivity of lithium ion in the first positive electrode active material is too high as compared to that of the second positive electrode active material, so that the first positive electrode active material is likely to react preferentially when a short circuit occurs, resulting in the heat generation by thermal runaway. When the ratio P1/P2 is attempted to make less than 0.30, the crystallite diameter of the second positive electrode active material needs to be made extremely small, which makes the material synthesis itself difficult because the crystallinity of the second positive electrode active material tends to be extremely low. The Cu-Kα radiation is a Kα beam generated by targeting copper (Cu). The X-ray diffraction measurement is performed using the positive electrode before being assembled as the non-aqueous electrolyte secondary battery or the positive electrode at 0% charge rate (SOC) of the non-aqueous electrolyte secondary battery after the initial activation process with at least one cycle of charging and discharging.

In the third embodiment, in the positive electrode 4 of the non-aqueous electrolyte secondary battery 1, the positive electrode mixed material layer 42 is made to have the first positive electrode active material represented by the general formula (1) and the second positive electrode active material including a compound represented by the general formula (2). And also in the X-ray diffraction pattern obtained by X-ray diffraction measurement, using a Cu-Kα radiation, of the positive electrode before being assembled as the non-aqueous electrolyte secondary battery, or of the positive electrode of the non-aqueous electrolyte secondary battery at 0% of SOC after the initial activation process with at least one cycle of charging and discharging, the ratio value P1/P2 is made 0.30 or more and 1.00 or less, where P1 is a half width of the peak attributable to the (003) plane of the first positive electrode active material and P2 is a half width of the peak attributed to the (101) plane of the second positive electrode active material. By satisfying the above conditions and making the crystallite diameter of the first positive electrode active material greater than that of the second positive electrode active material, the increase in the lithium diffusivity of the first positive electrode active material is suppressed more as compared to that of the second positive electrode active material. In the third embodiment, in the positive electrode mixed material layer 42, for example, the lithium ion becomes difficult to diffuse to the first positive electrode active material during a short circuit, so that the thermal decomposition of the first positive electrode active material can be suppressed. According to the third embodiment, it is possible to obtain the positive electrode 4 and the non-aqueous electrolyte secondary battery 1 that suppress the heat generation even when an abrupt short circuit occurs.

### Fourth Embodiment

Next, a fourth embodiment of the present invention will be described. The non-aqueous electrolyte secondary battery according to the third embodiment has the same composition elements as the non-aqueous electrolyte secondary battery 1 according to the first embodiment (see FIG. 1). Hereinafter, explanation will be made as to the parts that are different from the first embodiment.

Similarly to the first embodiment, the positive electrode 4 consists of the positive electrode current collector 41 and the positive electrode mixed material layer 42 formed on one or both sides of the positive electrode current collector 41. The positive electrode mixed material layer 42 includes the first positive electrode active material and the second positive electrode active material, the electrically conductive agent, and the binding agent.

In the fourth embodiment, in the positive electrode 4 of the non-aqueous electrolyte secondary battery 1, the positive electrode mixed material layer 42 has the first positive electrode active material represented by the general formula (1) and the second positive electrode active material containing a compound represented by the general formula (2). Similarly to the first embodiment, it is preferable that the median diameter of the first positive electrode active material is larger than D90 of the second positive electrode active material, and that the weight ratio of the second positive electrode active material to the total weight of the first positive electrode active material and the second positive electrode active material is 10% or more and 30% or less, and the tapped density of the second positive electrode active material is preferably 0.7 g/cc or more and 1.00 g/cc or less, and more preferably 0.8 g/cc or more.

Conventional technologies represented by those in Patent Literatures 1 and 2 had been focusing mainly on the particle diameter of the first positive electrode active material and of the second positive electrode active material in order to suppress the heat generation during a short circuit. However, the inventor of the present application carried out an extensive investigation; as a result, it became apparent that the specific surface area, not the particle diameter of each positive electrode active material, is important. In general, even the positive electrode active materials having roughly the same particle diameter can have significantly different specific surface areas depending on their shape, so simply controlling the particle diameter alone could not produce the desired results. Here, when the specific surface area of the first positive electrode active material is represented by S1 and the specific surface area of the second positive electrode active material is represented by S2, the ratio value of the specific surface area S1 to the specific surface area S2 (S1/S2) is 0.005 or more and 0.025 or less. More preferably, it is 0.010 or more and 0.020 or less. When the ratio value S1/S2 is 0.025 or less, that is, when the specific surface area of the second positive electrode active material is significantly larger than that of the first positive electrode active material, in the positive electrode mixed material layer 42, it is easier for the second positive electrode active material to adopt a structure that surrounds the first positive electrode active material. Therefore, even in the event of an abrupt short circuit, the exothermic reaction between the first positive electrode active material and the non-aqueous electrolyte can be suppressed as much as possible, and the heat generation of the non-aqueous electrolyte secondary battery can be suppressed. The specific surface area is the surface area per unit area. When the ratio value S1/S2 is less than 0.005, i.e., when the specific surface area of the second positive electrode active material is extremely large as compared to the specific surface area of the first positive electrode active material, the dispersibility of the second positive electrode active material during preparation of the slurry of the positive electrode mixed material layer 42 decreases, so that agglomeration takes place readily. Because the mixing state of the first positive electrode active material and the second positive electrode active material deteriorates due to agglomeration, the second positive electrode active material is thought to be less able to surround the first positive electrode active material without void spaces than the conventional one; thus, the heat generation during a short circuit cannot be suppressed sufficiently well. When the ratio value S1/S2 is greater than 0.025, the second positive electrode active material is considered to be less able to surround the first positive electrode active material without void spaces than the conventional one; thus, the heat generation during a short circuit cannot be suppressed sufficiently well.

Although the specific surface areas mentioned above refer to the values in the positive electrode mixed material layer 42 after forming the non-aqueous electrolyte secondary battery, they are almost the same values as the specific surface area of the first positive electrode active material and of the second positive electrode active material before forming the positive electrode. Therefore, when the specific surface areas before forming the positive electrode satisfy the requirements of the present invention, the formed positive electrode can also be considered to satisfy the requirements of the present invention.

In the fourth embodiment, in the positive electrode 4 of the non-aqueous electrolyte secondary battery 1, the positive electrode mixed material layer 42 is made to have the first positive electrode active material represented by the general formula (1) and the second positive electrode active material including a compound represented by the general formula (2), and the ratio value S1/S2 is made 0.005 or more 0.025 or less, where S1 represents the specific surface area of the first positive electrode active material and S2 represents the specific surface area of the second positive electrode active material. By satisfying the above conditions in the positive electrode mixed material layer 42, the second positive electrode active material covers the first positive electrode active material and the decomposition of the electrolyte solution on the surface of the first positive electrode active material is suppressed, making the thermal runaway at the time of a short circuit difficult to occur. According to the fourth embodiment, it is possible to obtain the positive electrode 4 and the non-aqueous electrolyte secondary battery 1 that suppress the heat generation even when an abrupt short circuit occurs.

### Fifth Embodiment

FIG. 2 is a perspective view of the disassembled non-aqueous electrolyte secondary battery equipped with the positive electrode for a non-aqueous electrolyte secondary battery according to a fifth embodiment of the present invention to explain the configuration thereof. A non-aqueous electrolyte secondary battery 1A has a case 110, a plate spring 111, a positive electrode current collector 112, a positive electrode mixed material layer 113, a separator 114, a negative electrode 115, a gasket 116, and a cap 117. The positive electrode current collector 112 and the positive electrode mixed material layer 113 constitute a positive electrode 118.

In the non-aqueous electrolyte secondary battery 1A, the case 110 and the cap 117 are adhered together by caulking or other means, and the inside thereof is filled with the non-aqueous electrolyte. A non-aqueous electrolyte secondary battery 1A is liquid-tightly sealed by the case 110, the gasket 116, and the cap 117. The positive electrode current collector 112, the positive electrode mixed material layer 113, the separator 114, and the negative electrode 115 are pressed toward the cap 117 by the plate spring 111. This keeps these members in the state of an intimate contact with each other.

The positive electrode current collector 112 is composed of the same material as the positive electrode current collector 41.

The positive electrode mixed material layer 113 has the same composition as the positive electrode active material layer 42.

The separator 114 is installed between the positive electrode and the negative electrode 115 and has a porous disc-like shape. The separator 114 has the same composition as the separator 6.

The non-aqueous electrolyte of the first embodiment may be used as the non-aqueous electrolyte.

The negative electrode 115 has the same composition as the negative electrode 5.

In the fifth embodiment, in the positive electrode 118 of the non-aqueous electrolyte secondary battery 1A, the positive electrode mixed material layer 113 is made to have the first positive electrode active material represented by the general formula (1) and the second positive electrode active material including a compound represented by the general formula (2), and the median diameter of the first positive electrode active material is made to be greater than D90 of the second positive electrode active material. By satisfying the above conditions in the positive electrode mixed material layer 113, the second positive electrode active material covers the first positive electrode active material and the decomposition of the electrolyte solution on the surface of the first positive electrode active material is suppressed, making the thermal runaway at the time of a short circuit difficult to occur. According to the fifth embodiment, it is possible to obtain the positive electrode 118 and the non-aqueous electrolyte secondary battery 1A that suppress the heat generation even when an abrupt short circuit occurs.

In addition, in the fifth embodiment, by employing the positive electrode according to the second to the fourth embodiments, the respective effects of the second to the fourth embodiments can be obtained in the non-aqueous electrolyte secondary battery 1A.

### EXAMPLES

Hereinafter, the present invention will be described in more detail by means of Examples; but the present invention is not limited at all by the Examples below.

### Example 1

### <Positive Electrode Preparation Method>

The slurry of the positive electrode active material was prepared by mixing 75.2% by weight of LiNi_{0.5}Co_{0.2}Mn_{0.3}O₂ (NCM) as the first positive electrode active material, 18.8% by weight of LiMn_{0.7}Fe_{0.3}PO₄ (LMFP) as the second positive electrode active material, 2% by weight of graphite as the first electrically conductive agent, 3% by weight of acetylene black as the second electrically conductive agent, 1% by weight of polyvinylidene fluoride (PVDF) as the binding agent, and an appropriate amount of N-methyl-2-pyrrolidone (NMP) as the viscosity adjusting solvent. The ratio of the weight of the second positive electrode active material to the total weight of the first positive electrode active material and the second positive electrode active material may be calculated from the % by weight of the first positive electrode active material and of the second positive electrode active material at the time of preparation of the slurry, although it may also be calculated by separation as described before.

The resulting slurry of the positive electrode active material was applied to both sides of the positive electrode current collector formed of aluminum foil and having a thickness of 20 μm; then this was dried to form the positive electrode mixed material layer. The coating amount of the positive electrode mixed material layer per one side thereof was made 99 g/m². Next, the positive electrode was pressed to make the density of the positive electrode mixed material layer 2.7 g/cc. The positive electrode mixed material layer was then cut such that the uncoated portion protruded as the positive electrode lead in a rectangular shape from one side of a rectangle of the portion coated with the positive electrode mixed material layer. In the protruding portion, the positive electrode active material layer is not formed, and this functions as the positive electrode lead.

### <Negative Electrode Preparation Method>

The slurry of the negative electrode active material was prepared by mixing 96.7% by weight of graphite as the negative electrode active material, 0.3% by weight of acetylene black as the electrically conductive agent, 1.5% by weight of styrene butadiene rubber as the binding agent, 1.5% by weight of carboxymethyl cellulose as the thickener, and an appropriate amount of ion exchanged water as the viscosity adjusting solvent.

The resulting slurry of the negative electrode active material was applied to both sides of the negative electrode current collector formed of 10 μm thick copper foil; then this was dried to form the negative electrode mixed material layer to obtain the negative electrode. The coating amount of the negative electrode mixed material layer per one side thereof was made 58 g/m². Next, the negative electrode was pressed to make the density of the negative electrode mixed material layer 1.2 g/cc. The negative electrode mixed material layer was then cut such that the uncoated portion protruded as the negative electrode lead in a rectangular shape from one side of the rectangle in the portion formed with the negative electrode mixed material layer. In the protruding portion, the negative electrode mixed material layer is not formed, and this functions as the negative electrode lead.

### Preparation of Non-Aqueous Electrolyte Solution

In the mixture of ethylene carbonate, ethyl methyl carbonate, and dimethyl carbonate with the ratio of 2:5:3 by volume, 1.3 mol/L of LiPF₆ as the lithium salt and 3% by weight of vinylene carbonate as the additive were dissolved, and the resulting solution was used as the non-aqueous electrolyte.

### Preparation of Electrode Element

Next, the electrode element was prepared by alternately stacking the positive electrode having the positive electrode current collection lead and the negative electrode having the negative electrode current collection lead to the sinuously connected separator. The separator having the polypropylene surface layer formed on both sides of polyethylene substrate layer (PE/PP/PE) was used. The thickness of the separator is 20 μm. Next, the positive electrode leads and the negative electrode leads were each bundled, and the positive electrode terminal was connected to the bundled positive electrode leads by an ultrasonic welding, and the negative electrode terminal was connected to the bundled negative electrode leads by an ultrasonic welding. The resulting electrode element had a thickness of 3.0 mm and a rated capacity of 4.8 Ah. The “rated capacity” here means the discharge capacity when a constant current/constant voltage charge (cutoff current: 0.05 C) with an upper limit voltage of 4.2 V and a current value of 0.5 C is followed by a constant current discharge with a lower limit voltage of 2.7 V and a current value of 0.2 C.

### Fabrication of Non-Aqueous Electrolyte Secondary Battery

Two sheets of the laminate film were prepared as the outer body, the laminate film having the structure in which a thermally bondable resin portion made of polyolefin, a metal layer made of aluminum foil, and a protective layer made of nylon resin and polyester resin were laminated in this order. The thermally bondable resin portions of the two laminate films were placed to face each other, such that the bondable surfaces of the laminate films were overlapped so as to accommodate the electrode group in the two housing recesses. The electrode group was placed such that between the perimeters of the two laminate films, the portion of each terminal where the thermally bondable resin portion was formed passed, and the portion of each terminal was exposed to the outside. In this state, the thermally bondable resin portions of the laminate films in the perimeters were thermally bonded to each other at three sides including the two sides from which each tab of those laminate films extended. Subsequently, the electrolyte solution prepared as described above was charged from one side where the outer body was not thermally bonded. Next, the remaining one side of the outer body was thermally bonded under a reduced pressure environment to obtain the non-aqueous electrolyte secondary battery (cell).

### <Measurement of Particle Diameter>

The median diameters of NCM and LMFP used were the particle diameters indicating the 50% relative particle amount (D50) measured by the laser diffraction and scattering method as described in JIS standard Z8825:2013. In the same way, D90 of LMFP used was the particle diameter indicating 90% relative particle amount (D90). The laser diffraction particle diameter distribution analyzer SALD-2300 (manufactured by Shimadzu Corp.) was used in the measurement.

### <Tapped Density>

LMFP in powder form was placed in a vessel as described in JIS Standard Z2504:2020. The vessel was then tapped 100 times to measure the weight divided by the volume in which the void spaces among the particles were packed; this value was used as the tapped density. A shaking specific gravity analyzer was used for the measurement.

### <Nail Penetration Test>

The fabricated non-aqueous electrolyte secondary battery (cell) was charged in advance with a constant current/constant voltage charge (cutoff current: 0.05 C) with an upper limit voltage of 4.2 V and a current value of 0.5 C. A nail (stainless steel, 3 mm in diameter) was inserted into the center of the cell at a nailing speed of 0.1 mm/s and a nailing depth of just before the end of penetration (3.0 mm); and the maximum surface temperature of the cell after nailing (hereinafter referred to as “surface temperature”) was measured. The appearance of the cell was also checked one hour after the nailing to see if there was any cleavage outside of the nailing area. This test was carried out with referring to the international standard IEC TR 62660-4, but the nailing depth was set deeper to generate more heat than in IEC TR 62660-4 so that more positive electrodes and negative electrodes were short-circuited at the same time, meaning that the test was conducted under very severe short-circuit conditions.

### Example 1-1

The non-aqueous electrolyte secondary battery was fabricated using the positive electrode having the physical properties listed in Table 1 as the positive electrode mixed material layer. After the nail penetration test, there was no cell cleavage, and the surface temperature was 78° C.

TABLE 1

| | | | | | | Cell | |
|---|---|---|---|---|---|---|---|
| | | | | Tapped | Ratio | temperature | |
| | D50 of | D90 of | D50 of | density of | of | after | Cell |
| | NCM | LMFP | LMFP | LMFP | LMFP | nailing | cleavage |
| | [um] | [um] | [um] | [g/cc] | [%] | [° C.] | Yes/No |
| Example 1-1 | 11.9 | 8.9 | 0.9 | 0.96 | 20 | 78 | No |
| Example 1-2 | 11.9 | 3.4 | 1.0 | 1.04 | 20 | 154 | Yes |
| Example 1-3 | 11.9 | 4.5 | 0.9 | 0.81 | 20 | 99 | No |
| Example 1-4 | 4.3 | 3.7 | 0.9 | 0.96 | 20 | 160 | Yes |
| Example 1-5 | 4.9 | 3.7 | 0.9 | 0.96 | 20 | 101 | No |
| Example 1-6 | 11.9 | 9.5 | 4.3 | 0.91 | 20 | 122 | Yes |
| Example 1-7 | 11.9 | 4.3 | 1.1 | 0.88 | 20 | 131 | Yes |
| Example 1-8 | 11.9 | 7.6 | 0.8 | 0.76 | 20 | 84 | No |
| Example 1-9 | 11.9 | 6.9 | 0.8 | 0.69 | 20 | 87 | No |
| Example 1-10 | 14.0 | 7.6 | 0.8 | 0.76 | 20 | 90 | No |
| Example 1-11 | 51.4 | 7.2 | 0.5 | 0.79 | 20 | 75 | No |
| Example 1-12 | 11.9 | 7.2 | 0.5 | 0.79 | 20 | 86 | No |
| Example 1-13 | 11.9 | 8.9 | 0.9 | 0.96 | 5 | 136 | Yes |
| Example 1-14 | 11.9 | 8.9 | 0.9 | 0.96 | 10 | 107 | No |
| Example 1-15 | 11.9 | 8.9 | 0.9 | 0.96 | 30 | 69 | No |
| Comparative | 11.9 | 12.1 | 4.8 | 0.98 | 20 | 457 | Yes |
| Example 1-1 | | | | | | | |
| Comparative | 11.9 | 12.4 | 5.1 | 1.20 | 20 | 511 | Yes |
| Example 1-2 | | | | | | | |
| Comparative | 6.2 | 8.9 | 0.9 | 0.96 | 20 | 532 | Yes |
| Example 1-3 | | | | | | | |

### Example 1-2

The non-aqueous electrolyte secondary battery was fabricated using the positive electrode having the physical properties listed in Table 1 as the positive electrode mixed material layer. The conditions are the same as those in Example 1-1, except that in LMFP, D90 is 3.4 μm, D50 is 1.0 μm, and the tapped density is 1.04 g/cc. After the nail penetration test, the cell was cleaved, and the surface temperature was 154° C.

### Example 1-3

The non-aqueous electrolyte secondary battery was fabricated using the positive electrode having the physical properties listed in Table 1 as the positive electrode mixed material layer. The conditions are the same as those in Example 1-1, except that in LMFP, D90 is 4.5 μm and the tapped density is 0.81 g/cc. After the nail penetration test, there was no cell cleavage, and the surface temperature was 99° C.

### Example 1-4

The non-aqueous electrolyte secondary battery was fabricated using the positive electrode having the physical properties listed in Table 1 as the positive electrode mixed material layer. The conditions are the same as those in Example 1-1, except that D50 of NCM is 4.3 μm, and D90 of LMFP is 3.7 μm. After the nail penetration test, the cell was cleaved, and the surface temperature was 160° C.

### Example 1-5

The non-aqueous electrolyte secondary battery was fabricated using the positive electrode having the physical properties listed in Table 1 as the positive electrode mixed material layer. The conditions are the same as those in Example 1-1, except that D90 of LMFP is 4.9 μm and D90 of LMFP is 3.7 μm. After the nail penetration test, there was no cell cleavage, and the surface temperature was 101° C.

### Example 1-6

The non-aqueous electrolyte secondary battery was fabricated using the positive electrode having the physical properties listed in Table 1 as the positive electrode mixed material layer. The conditions are the same as those in Example 1-1, except that in LMFP, D90 is 9.5 μm, D50 is 4.3 μm, and the tapped density is 0.91 g/cc. After the nail penetration test, the cell was cleaved, and the surface temperature was 122° C.

### Example 1-7

The non-aqueous electrolyte secondary battery was fabricated using the positive electrode having the physical properties listed in Table 1 as the positive electrode mixed material layer. The conditions are the same as those in Example 1-1, except that in LMFP, D90 is 4.3 μm, D50 is 1.1 μm, and the tapped density is 0.88 g/cc. After the nail penetration test, the cell was cleaved, and the surface temperature was 131° C.

### Example 1-8

The non-aqueous electrolyte secondary battery was fabricated using the positive electrode having the physical properties listed in Table 1 as the positive electrode mixed material layer. The conditions are the same as those in Example 1-1, except that in LMFP, D90 is 7.6 μm, D50 is 0.8 μm, and the tapped density is 0.76 g/cc. After the nail penetration test, there was no cell cleavage, and the surface temperature was 84° C.

### Example 1-9

The non-aqueous electrolyte secondary battery was fabricated using the positive electrode having the physical properties listed in Table 1 as the positive electrode mixed material layer. The conditions are the same as those in Example 1-1, except that in LMFP, D90 is 6.9 μm, D50 is 0.8 μm, and the tapped density is 0.69 g/cc. After the nail penetration test, there was no cell cleavage, and the surface temperature was 87° C. However, the positive electrode had numerous threading marks, making it unsuitable for continuous production and thus industrially undesirable.

### Example 1-10

The non-aqueous electrolyte secondary battery was fabricated using the positive electrode having the physical properties listed in Table 1 as the positive electrode mixed material layer. The conditions are the same as those in Example 1-1, except that in NCM D50 is 14.0 μm, and in LMFP D90 is 7.6 μm, D50 is 0.8 μm, and the tapped density is 0.76 g/cc. After the nail penetration test, there was no cell cleavage, and the surface temperature was 90° C.

### Example 1-11

The non-aqueous electrolyte secondary battery was fabricated using the positive electrode having the physical properties listed in Table 1 as the positive electrode mixed material layer. The conditions are the same as those in Example 1-1, except that in NCM D50 is 51.4 μm, and in LMFP D90 is 7.2 μm, D50 is 0.5 μm, and the tapped density is 0.79 g/cc. After the nail penetration test, there was no cell cleavage, and the surface temperature was 75° C. However, the positive electrode had numerous threading marks, making it unsuitable for continuous production and thus industrially undesirable.

### Example 1-12

The non-aqueous electrolyte secondary battery was fabricated using the positive electrode having the physical properties listed in Table 1 as the positive electrode mixed material layer. The conditions are the same as those in Example 1-1, except that in LMFP, D90 is 7.2 μm, D50 is 0.5 μm, and the tapped density is 0.79 g/cc. After the nail penetration test, there was no cell cleavage, and the surface temperature was 86° C.

### Example 1-13

The non-aqueous electrolyte secondary battery was fabricated using the positive electrode having the physical properties listed in Table 1 as the positive electrode mixed material layer. The conditions are the same as those in Example 1-1, except that the percentage of LMFP is 5%. After the nail penetration test, the cell was cleaved, and the surface temperature was 136° C.

### Example 1-14

The non-aqueous electrolyte secondary battery was fabricated using the positive electrode having the physical properties listed in Table 1 as the positive electrode mixed material layer. The conditions are the same as those in Example 1-1, except that the percentage of LMFP is 10%. After the nail penetration test, there was no cell cleavage, and the surface temperature was 107° C.

### Example 1-15

The non-aqueous electrolyte secondary battery was fabricated using the positive electrode having the physical properties listed in Table 1 as the positive electrode mixed material layer. The conditions are the same as those in Example 1-1, except that the percentage of LMFP is 30%. After the nail penetration test, there was no cell cleavage, and the surface temperature was 69° C.

### Comparative Example 1-1

The non-aqueous electrolyte secondary battery was fabricated using the positive electrode having the physical properties listed in Table 1 as the positive electrode mixed material layer. The conditions are the same as those in Example 1-1, except that in LMFP, D90 is 12.1 μm, D50 is 4.8 μm, and the tapped density is 0.98 g/cc. After the nail penetration test, the cell was cleaved, and the surface temperature was 457° C.

### Comparative Example 1-2

The non-aqueous electrolyte secondary battery was fabricated using the positive electrode having the physical properties listed in Table 1 as the positive electrode mixed material layer. The conditions are the same as those in Example 1-1, except that in LMFP, D90 is 12.4 μm, D50 is 5.1 μm, and the tapped density is 1.20 g/cc. After the nail penetration test, the cell was cleaved, and the surface temperature was 511° C.

### Comparative Example 1-3

The non-aqueous electrolyte secondary battery was fabricated using the positive electrode having the physical properties listed in Table 1 as the positive electrode mixed material layer. The conditions are the same as those in Example 1-1, except that D50 of NCM is 6.2 μm. After the nail penetration test, the cell was cleaved, and the surface temperature was 532° C.

As can be seen in Table 1, Examples 1-1 to 1-15 showed a surface temperature of 160° C. or lower after nailing. On the other hand, in Comparative Examples 1-1 to 1-3, the cells were cleaved, and the surface temperatures were as high as 450° C. or higher. In Comparative Examples 1-1 to 1-3, meltdown of the separator occurred, suggesting that a short circuit occurred inside the cell to cause the successive heat generation. From these results, it can be said that Examples 1-1 to 1-15 have a thermal stability because the heat generation due to the thermal runaway during a short circuit is suppressed. Among them, Examples 1-1, 1-3, 1-5, 1-8 to 1-12, 1-14, and 1-15 showed no cell cleavage. Therefore, it can be said that they have an especially excellent thermal stability.

### Example 2

### <Positive Electrode Preparation Method>

The slurry of the positive electrode active material was prepared by mixing 75.2% by weight of LiNi_{0.5}Co_{0.2}Mn_{0.3}O₂ (NCM) as the first positive electrode active material, 18.8% by weight of LiMn_{0.7}Fe_{0.3}PO₄ (LMFP) as the second positive electrode active material, 2% by weight of graphite as the first electrically conductive agent, 3% by weight of acetylene black as the second electrically conductive agent, 1% by weight of polyvinylidene fluoride (PVDF) as the binding agent, and an appropriate amount of N-methyl-2-pyrrolidone (NMP) as the viscosity adjusting solvent.

The resulting slurry of the positive electrode active material was applied to both sides of the positive electrode current collector formed of aluminum foil and having a thickness of 20 μm; then this was dried to form the positive electrode mixed material layer. The coating amount of the positive electrode mixed material layer per one side thereof was made 99 g/m². Next, the positive electrode was pressed. The positive electrode mixed material layer was then cut such that the uncoated portion protruded as the positive electrode lead in a rectangular shape from one side of a rectangle of the portion coated with the positive electrode mixed material layer. In the protruding portion, the positive electrode active material layer is not formed, and this functions as the positive electrode lead.

### <Negative Electrode Preparation Method>

The slurry of the negative electrode active material was prepared by mixing 96.7% by weight of graphite as the negative electrode active material, 0.3% by weight of acetylene black as the electrically conductive agent, 1.5% by weight of styrene butadiene rubber as the binding agent, 1.5% by weight of carboxymethyl cellulose as the thickener, and an appropriate amount of ion exchanged water as the viscosity adjusting solvent.

The resulting slurry of the negative electrode active material was applied to both sides of the negative electrode current collector formed of 10 μm thick copper foil; then this was dried to form the negative electrode mixed material layer to obtain the negative electrode. The coating amount of the negative electrode mixed material layer per one side thereof was made 58 g/m². Next, the negative electrode was pressed to make the density of the negative electrode mixed material layer 1.2 g/cc. Then, it was cut such that the uncoated portion protruded rectangularly from one side of the rectangle where the negative electrode mixed material layer was formed. In the protruding portion, the negative electrode mixed material layer is not formed, and this functions as the negative electrode lead.

### Preparation of Non-Aqueous Electrolyte

In the mixture of ethylene carbonate, ethyl methyl carbonate, and dimethyl carbonate with the ratio of 2:5:3 by volume, 1.3 mol/L of LiPF₆ as the lithium salt and 3% by weight of vinylene carbonate as the additive were dissolved, and the resulting solution was used as the non-aqueous electrolyte.

### Preparation of Electrode Element

Next, the electrode element was prepared by alternately stacking the positive electrode having the positive electrode current collection lead and the negative electrode having the negative electrode current collection lead to the sinuously connected separator. The separator having the polypropylene surface layer formed on both sides of polyethylene substrate layer (PE/PP/PE) was used. The thickness of the separator is 20 μm. Next, the positive electrode leads and the negative electrode leads were bundled respectively, and the positive electrode terminal was connected to the bundled positive electrode leads by an ultrasonic welding, and the negative electrode terminal was connected to the bundled negative electrode leads by an ultrasonic welding. The resulting electrode element had a thickness of 3.0 mm and a rated capacity of 4.8 Ah. The “rated capacity” here means the discharge capacity when a constant current/constant voltage charge (cutoff current: 0.05 C) with an upper limit voltage of 4.2 V and a current value of 0.5 C is followed by a constant current discharge with a lower limit voltage of 2.7 V and a current value of 0.2 C.

### Fabrication of Non-Aqueous Electrolyte Secondary Battery

Two sheets of the laminate film were prepared as the outer body, the laminate film having the structure in which a thermally bondable resin layer made of polyolefin, a metal layer made of aluminum foil, and a protective layer made of nylon resin and polyester resin were laminated in this order. The thermally bondable resin layers of the two laminate films were placed to face each other such that the bondable surfaces of the laminate films were overlapped so as to accommodate the electrode group in the two housing recesses. The electrode group was placed such that between the perimeters of the two laminate films, the portion of each terminal where the thermally bondable resin portion was formed passed, and the portion of each terminal was exposed to the outside. In this state, the thermally bondable resin layers were thermally bonded to each other at the perimeters of the laminate films on three sides including the two sides from which each tab of those laminate films extends. Subsequently, the electrolyte solution prepared as described above was charged from one side where the outer body was not thermally bonded. Next, the remaining one side of the outer body was thermally bonded under a reduced pressure environment to obtain the non-aqueous electrolyte secondary battery (cell).

### <Tapped Density>

The tapped densities of NCM and of LMFP in powder form were measured using the same method as in Example 1.

### <Measurement of Particle Diameter>

Similarly to Example 1, the median diameter of NCM and D90 of LMFP were measured.

### <Initial Activation of Battery>

The fabricated cell was transferred to a constant temperature chamber set at 25° C.; then the initial activation process with 5 cycles was performed. In the first cycle of charging and discharging, the charging was performed with the constant current/constant voltage charge with a current of 0.1 C, an upper limit voltage of 4.2 V, and a cutoff current of 0.05 C, and the discharging was performed with the constant current discharge with a current of 0.5 C and a lower limit voltage of 2.7 V. In the second through fifth cycles of charging and discharging, the charging was performed with the constant current/constant voltage charge with a current of 0.2 C, a voltage of 4.2 V, and a cutoff current of 0.05 C, and the discharging was performed with the constant current discharge with a current of 0.2 C and a termination voltage of 2.7 V. A 15-minute pause was set after the charging and after the discharging. After completion of the fifth cycle, the SOC was adjusted to 20% by charging at 0.2 C for 1 hour.

### <Measurement of Density After Initial Activation>

In addition to the cell used for the nail penetration test to be described below, the cell was prepared that was processed up to the initial activation under exactly the same conditions as described above. After adjusting the SOC to 0% by the constant current discharge with a current of 0.5 C and a lower limit voltage of 2.7 V, the cell was disassembled in an argon-filled glove box and the positive electrode was taken out. The density D after the initial activation was calculated from the thickness of this positive electrode.

### <Nail Penetration Test>

Similarly to Example 1, the surface temperature of the cell after nailing was measured for the fabricated non-aqueous electrolyte secondary battery (cell). The appearance of the cell was also checked one hour after the nailing to see if there was any cleavage outside of the nailing area.

### Example 2-1

The non-aqueous electrolyte secondary battery was fabricated using the positive electrode having the physical properties listed in Table 2 as the positive electrode mixed material layer. The value of (W1×R1+W2×R2)/D was 0.900. The density of the positive electrode mixed material layer immediately after pressing was 2.70 g/cc. After the nail penetration test, there was no cell cleavage, and the surface temperature was 78° C.

TABLE 2

| | | | | | | | | | Surface | |
|---|---|---|---|---|---|---|---|---|---|---|
| | | | | | | | D50 of | D90 of | temperature | Cell |
| | W1 | W2 | | | D | (W1 × R1 + | NCM | LMFP | after nailing | cleavage |
| | [g/cc] | [g/cc] | R1 | R2 | [g/cc] | W2 × R2)/D | [μm] | [μm] | [° C.] | Yes/No |
| Example 2-1 | 2.65 | 0.960 | 0.800 | 0.200 | 2.57 | 0.900 | 11.9 | 8.90 | 78 | No |
| Example 2-2 | 2.65 | 0.800 | 0.800 | 0.200 | 2.57 | 0.887 | 11.9 | 12.4 | 122 | Yes |
| Example 2-3 | 2.65 | 1.05 | 0.800 | 0.200 | 2.57 | 0.907 | 11.9 | 9.50 | 136 | Yes |
| Example 2-4 | 2.65 | 0.790 | 0.800 | 0.200 | 2.57 | 0.886 | 11.9 | 9.70 | 94 | No |
| Example 2-5 | 2.80 | 0.960 | 0.800 | 0.200 | 2.55 | 0.954 | 14.0 | 8.90 | 98 | No |
| Example 2-6 | 2.65 | 0.960 | 0.800 | 0.200 | 2.48 | 0.932 | 11.9 | 8.90 | 104 | No |
| Example 2-7 | 2.65 | 0.960 | 0.800 | 0.200 | 2.86 | 0.808 | 11.9 | 8.90 | 74 | No |
| Example 2-8 | 2.65 | 0.960 | 0.700 | 0.300 | 2.40 | 0.893 | 11.9 | 8.90 | 72 | No |
| Example 2-9 | 2.65 | 0.960 | 0.900 | 0.100 | 2.76 | 0.899 | 11.9 | 8.90 | 129 | No |
| Example 2-10 | 2.51 | 0.960 | 0.800 | 0.200 | 2.86 | 0.769 | 9.80 | 8.90 | 88 | No |
| Example 2-11 | 2.65 | 0.960 | 0.950 | 0.0500 | 2.76 | 0.930 | 11.9 | 8.90 | 142 | Yes |
| Example 2-12 | 2.65 | 1.06 | 0.800 | 0.200 | 2.57 | 0.907 | 11.9 | 14.6 | 143 | Yes |
| Example 2-13 | 2.80 | 1.06 | 0.800 | 0.200 | 2.57 | 0.954 | 14.0 | 14.6 | 149 | Yes |
| Example 2-14 | 2.69 | 0.690 | 0.800 | 0.200 | 2.57 | 0.891 | 11.9 | 7.80 | 88 | No |
| Comparative | 2.65 | 0.960 | 0.800 | 0.200 | 2.40 | 0.963 | 11.9 | 8.90 | 511 | Yes |
| Example 2-1 | | | | | | | | | | |
| Comparative | 2.85 | 0.960 | 0.800 | 0.200 | 2.57 | 0.962 | 17.3 | 8.90 | 485 | Yes |
| Example 2-2 | | | | | | | | | | |
| Comparative | 2.65 | 0.960 | 0.900 | 0.100 | 2.57 | 0.965 | 11.9 | 8.90 | 539 | Yes |
| Example 2-3 | | | | | | | | | | |
| Comparative | 2.85 | 0.960 | 0.700 | 0.300 | 2.36 | 0.967 | 17.3 | 8.90 | 601 | Yes |
| Example 2-4 | | | | | | | | | | |
| Comparative | 2.80 | 1.21 | 0.800 | 0.200 | 2.57 | 0.966 | 14.6 | 8.90 | 574 | Yes |
| Example 2-5 | | | | | | | | | | |

### Example 2-2

The non-aqueous electrolyte secondary battery was fabricated using the positive electrode having the physical properties listed in Table 2 as the positive electrode mixed material layer. The conditions are the same as those in Example 2-1, except that the tapped density W2 is 0.800 g/cc and D90 of LMFP is 12.4 μm. The value of (W1×R1+W2×R2)/D was 0.887. After the nail penetration test, the cell was cleaved, and the surface temperature was 122° C.

### Example 2-3

The non-aqueous electrolyte secondary battery was fabricated using the positive electrode having the physical properties listed in Table 2 as the positive electrode mixed material layer. The conditions are the same as those in Example 2-1, except that the tapped density W2 is 1.05 g/cc and D90 of LMFP is 9.50 μm. The value of (W1×R1+W2×R2)/D was 0.907. After the nail penetration test, the cell was cleaved, and the surface temperature was 136° C.

### Example 2-4

The non-aqueous electrolyte secondary battery was fabricated using the positive electrode having the physical properties listed in Table 2 as the positive electrode mixed material layer. The conditions are the same as those in Example 2-1, except that the tapped density W2 is 0.790 g/cc and D90 of LMFP is 9.70 μm. The value of (W1×R1+W2×R2)/D was 0.886. After the nail penetration test, there was no cell cleavage, and the surface temperature was 94° C.

### Example 2-5

The non-aqueous electrolyte secondary battery was fabricated using the positive electrode having the physical properties listed in Table 2 as the positive electrode mixed material layer. The conditions are the same as those in Example 2-1, except that the tapped density W1 is 2.80 g/cc, the density D is 2.55 g/cc, and D50 of NCM is 14.0. The value of (W1×R1+W2×R2)/D was 0.954. After the nail penetration test, there was no cell cleavage, and the surface temperature was 98° C.

### Example 2-6

The non-aqueous electrolyte secondary battery was fabricated using the positive electrode having the physical properties listed in Table 2 as the positive electrode mixed material layer. The conditions are the same as those in Example 2-1, except that the density of the positive electrode mixed material layer immediately after pressing is 2.60 g/cc and the density D after the initial activation is 2.48 g/cc. The value of (W1×R1+W2×R2)/D was 0.932. After the nail penetration test, there was no cell cleavage, and the surface temperature was 104° C.

### Example 2-7

The non-aqueous electrolyte secondary battery was fabricated using the positive electrode having the physical properties listed in Table 2 as the positive electrode mixed material layer. The conditions are the same as those in Example 2-1, except that the density of the positive electrode mixed material layer immediately after pressing is 3.00 g/cc and the density D after the initial activation is 2.86 g/cc. The value of (W1×R1+W2×R2)/D was 0.808. After the nail penetration test, there was no cell cleavage, and the surface temperature was 74° C.

### Example 2-8

The non-aqueous electrolyte secondary battery was fabricated using the positive electrode having the physical properties listed in Table 2 as the positive electrode mixed material layer. The conditions are the same as those in Example 2-1, except that the ratio R1 is 0.700, the ratio R2 is 0.300, the density of the positive electrode mixed material layer immediately after pressing is 2.5 g/cc, and the density D after the initial activation is 2.40 g/cc. The value of (W1×R1+W2×R2)/D was 0.893. After the nail penetration test, there was no cell cleavage, and the surface temperature was 72° C.

### Example 2-9

The non-aqueous electrolyte secondary battery was fabricated using the positive electrode having the physical properties listed in Table 2 as the positive electrode mixed material layer. The conditions are the same as those in Example 2-1, except that the ratio R1 is 0.900, the ratio R2 is 0.100, the density of the positive electrode mixed material layer immediately after pressing is 2.9 g/cc, and the density D after the initial activation is 2.76 g/cc. The value of (W1×R1+W2×R2)/D was 0.899. After the nail penetration test, there was no cell cleavage, and the surface temperature was 129° C.

### Example 2-10

The non-aqueous electrolyte secondary battery was fabricated using the positive electrode having the physical properties listed in Table 2 as the positive electrode mixed material layer. The conditions are the same as those in Example 2-1, except that the tapped density W1 is 2.51 g/cc, the density of the positive electrode mixed material layer immediately after pressing is 3.00 g/cc, the density after the initial activation D is 2.86 g/cc, and D50 of NCM is 9.80 μm. The value of (W1×R1+W2×R2)/D was 0.769. After the nail penetration test, there was no cell cleavage, and the surface temperature was 88° C.

### Example 2-11

The non-aqueous electrolyte secondary battery was fabricated using the positive electrode having the physical properties listed in Table 2 as the positive electrode mixed material layer. The conditions are the same as those in Example 2-1, except that the ratio R1 is 0.950, the ratio R2 is 0.0500, the density of the positive electrode mixed material layer immediately after pressing is 2.90 g/cc, and the density D after the initial activation is 2.76 g/cc. The value of (W1×R1+W2×R2)/D was 0.930. After the nail penetration test, the cell was cleaved, and the surface temperature was 142° C.

### Example 2-12

The non-aqueous electrolyte secondary battery was fabricated using the positive electrode having the physical properties listed in Table 2 as the positive electrode mixed material layer. The conditions are the same as those in Example 2-1, except that the tapped density W2 is 1.06 g/cc and D90 of LMFP is 14.6 μm. The value of (W1×R1+W2×R2)/D was 0.907. After the nail penetration test, the cell was cleaved, and the surface temperature was 143° C.

### Example 2-13

The non-aqueous electrolyte secondary battery was fabricated using the positive electrode having the physical properties listed in Table 2 as the positive electrode mixed material layer. The conditions are the same as those in Example 2-1, except that the tapped density W1 is 2.80 g/cc, the tapped density W2 is 1.06 g/cc, D50 of NCM is 14.0 μm, and D90 of LMFP is 14.6 μm. The value of (W1×R1+W2×R2)/D was 0.954. After the nail penetration test, the cell was cleaved, and the surface temperature was 149° C.

### Example 2-14

The non-aqueous electrolyte secondary battery was fabricated using the positive electrode having the physical properties listed in Table 2 as the positive electrode mixed material layer. The conditions are the same as those in Example 2-1, except that the tapped density W1 is 2.69 g/cc, the tapped density W2 is 0.690 g/cc, and D90 of LMFP is 7.80 μm. The value of (W1×R1+W2×R2)/D was 0.891. After the nail penetration test, there was no cell cleavage, and the surface temperature was 88° C. However, the positive electrode had numerous threading marks, making it unsuitable for continuous production and thus industrially undesirable.

### Comparative Example 2-1

The non-aqueous electrolyte secondary battery was fabricated using the positive electrode having the physical properties listed in Table 2 as the positive electrode mixed material layer. The conditions are the same as those in Example 2-1, except that the density of the positive electrode mixed material layer immediately after pressing is 2.50 g/cc and the density D after the initial activation is 2.40 g/cc. The value of (W1×R1+W2×R2)/D was 0.963. After the nail penetration test, the cell was cleaved, and the surface temperature was 511° C.

### Comparative Example 2-2

The non-aqueous electrolyte secondary battery was fabricated using the positive electrode having the physical properties listed in Table 2 as the positive electrode mixed material layer. The conditions are the same as those in Example 2-1, except that the tapped density W1 is 2.85 g/cc and D50 of NCM is 17.3 μm. The value of (W1×R1+W2×R2)/D was 0.962. After the nail penetration test, the cell was cleaved, and the surface temperature was 485° C.

### Comparative Example 2-3

The non-aqueous electrolyte secondary battery was fabricated using the positive electrode having the physical properties listed in Table 2 as the positive electrode mixed material layer. The conditions are the same as those in Example 2-1, except that the ratio R1 is 0.900 and the ratio R2 is 0.100. The value of (W1×R1+W2×R2)/D was 0.965. After the nail penetration test, the cell was cleaved, and the surface temperature was 539° C.

(Comparative Example 2-4) The non-aqueous electrolyte secondary battery was fabricated using the positive electrode having the physical properties listed in Table 2 as the positive electrode mixed material layer. The conditions are the same as those in Example 2-1, except that the tapped density W1 is 2.85 g/cc, the ratio R1 is 0.700, the ratio R2 is 0.300, the density of the positive electrode mixed material layer immediately after pressing is 2.50 g/cc, the density D after the initial activation is 2.36 g/cc, and D50 of NCM is 17.3 μm. The value of (W1×R1+W2×R2)/D was 0.967. After the nail penetration test, the cell was cleaved, and the surface temperature was 601° C.

### Comparative Example 2-5

The non-aqueous electrolyte secondary battery was fabricated using the positive electrode having the physical properties listed in Table 2 as the positive electrode mixed material layer. The conditions are the same as those in Example 2-1, except that the tapped density W1 is 2.80 g/cc, the tapped density W2 is 1.21 g/cc, the density D is 2.57 g/cc, and D50 of NCM is 14.0 μm. The value of (W1×R1+W2×R2)/D was 0.966. After the nail penetration test, the cell was cleaved, and the surface temperature was 574° C.

When the value of (W1×R1+W2×R2)/D was less than 0.760, the inside of the positive electrode mixed material layer was too dense, causing distortion at the pressing process during the electrode formation thereby possibly causing to lower the fabrication efficiency during the battery fabrication; thus, this was not carried out.

As can be seen in Table 2, Examples 2-1 to 2-14 showed a surface temperature of 149° C. or lower after nailing. On the other hand, in Comparative Examples 2-1 to 2-5, the cells were cleaved, and the surface temperatures were as high as 485° C. or higher. In Comparative Examples 2-1 to 2-5, meltdown of the separator occurred, suggesting that a short circuit occurred inside the cell to cause the successive heat generation. From these results, it can be said that Examples 2-1 to 2-14 have a thermal stability, because the heat generation during a short circuit is suppressed. Among them, in Examples 2-1 and 2-4 to 2-10 there was no industrial problem and there was no cell cleavage. Therefore, it can be said that they have an especially excellent thermal stability.

### Example 3

### <Positive Electrode Preparation Method>

The slurry of the positive electrode active material was prepared by mixing 75.2% by weight of LiNi_{0.5}Co_{0.2}Mn_{0.3}O₂ (NCM) as the first positive electrode active material, 18.8% by weight of LiMn_{0.7}Fe_{0.3}PO₄ (LMFP) as the second positive electrode active material, 2% by weight of graphite as the first electrically conductive agent, 3% by weight of acetylene black as the second electrically conductive agent, 1% by weight of polyvinylidene fluoride (PVDF) as the binding agent, and an appropriate amount of N-methyl-2-pyrrolidone (NMP) as the viscosity adjusting solvent.

The resulting slurry of the positive electrode active material was applied to both sides of the positive electrode current collector formed of aluminum foil and having a thickness of 20 μm; then this was dried to form the positive electrode mixed material layer. The coating amount of the positive electrode mixed material layer per one side thereof was made 99 g/m². Next, the positive electrode was pressed to make the density of the positive electrode mixed material layer 2.7 g/cc. The positive electrode mixed material layer was then cut such that the uncoated portion protruded as the positive electrode lead in a rectangular shape from one side of a rectangle of the portion coated with the positive electrode mixed material layer. In the protruding portion, the positive electrode active material layer is not formed, and this functions as the positive electrode lead.

### <Negative Electrode Preparation Method>

The slurry of the negative electrode active material was prepared by mixing 96.7% by weight of graphite as the negative electrode active material, 0.3% by weight of acetylene black as the electrically conductive agent, 1.5% by weight of styrene butadiene rubber as the binding agent, 1.5% by weight of carboxymethyl cellulose as the thickener, and an appropriate amount of ion exchanged water as the viscosity adjusting solvent.

The resulting slurry of the negative electrode active material was applied to both sides of the negative electrode current collector formed of 10 μm thick copper foil; then this was dried to form the negative electrode mixed material layer to obtain the negative electrode. The coating amount of the negative electrode mixed material layer per one side thereof was made 58 g/m². Next, the negative electrode was pressed to make the density of the negative electrode mixed material layer 1.2 g/cc. Then, it was cut such that the uncoated portion protruded rectangularly from one side of the rectangle where the negative electrode mixed material layer was formed. In the protruding portion, the negative electrode mixed material layer is not formed, and this functions as the negative electrode lead.

### Preparation of Non-Aqueous Electrolyte

In the mixture of ethylene carbonate, ethyl methyl carbonate, and dimethyl carbonate with the ratio of 2:5:3 by volume, 1.3 mol/L of LiPF₆ as the lithium salt and 3% by weight of vinylene carbonate as the additive were dissolved, and the resulting solution was used as the non-aqueous electrolyte.

### Preparation of Electrode Element

Next, the electrode element was prepared by alternately stacking the positive electrode having the positive electrode current collection lead and the negative electrode having the negative electrode current collection lead to the sinuously connected separator. The separator having the polypropylene surface layer formed on both sides of polyethylene substrate layer (PE/PP/PE) was used. The thickness of the separator is 20 μm. Next, the positive electrode leads and the negative electrode leads were bundled respectively, and the positive electrode terminal was connected to the bundled positive electrode leads by an ultrasonic welding, and the negative electrode terminal was connected to the bundled negative electrode leads by an ultrasonic welding. The resulting electrode element had a thickness of 3.0 mm and a rated capacity of 4.8 Ah. The “rated capacity” here means the discharge capacity when a constant current/constant voltage charge (cutoff current: 0.05 C) with an upper limit voltage of 4.2 V and a current value of 0.5 C is followed by a constant current discharge with a lower limit voltage of 2.7 V and a current value of 0.2 C.

### Fabrication of Non-Aqueous Electrolyte Secondary Battery

Two sheets of the laminate film were prepared as the outer body, the laminate film having the structure in which a thermally bondable resin layer made of polyolefin, a metal layer made of aluminum foil, and a protective layer made of nylon resin and polyester resin were laminated in this order. The thermally bondable resin layers of the two laminate films were placed to face each other such that the bondable surfaces of the laminate films were overlapped so as to accommodate the electrode group in the two housing recesses. The electrode group was placed such that between the perimeters of the two laminate films, the portion of each terminal where the thermally bondable resin portion was formed passed, and the portion of each terminal was exposed to the outside. In this state, the thermally bondable resin layers were thermally bonded to each other at the perimeters of the laminate films on three sides including the two sides from which each tab of those laminate films extends. Subsequently, the electrolyte solution prepared as described above was charged from one side where the outer body was not thermally bonded. Next, the remaining one side of the outer body was thermally bonded under a reduced pressure environment to obtain the non-aqueous electrolyte secondary battery (cell).

### <Measurement of Half-Width>

In the positive electrode before being assembled as the non-aqueous electrolyte secondary battery, the half-width P1 of the peak attributable to the (003) plane of NCM that exists at the diffraction angle (2θ) between 18.0° or more and 19.0° or less and the half-width P2 of the peak attributable to the (101) plane of LMFP that exists at the diffraction angle (2θ) between 20.0° or more and 21.0° or less were measured in the X-ray diffraction pattern obtained by the X-ray diffraction measurement using a Cu-Kα radiation.

### <Tapped Density>

Similarly to Example 1, the tapped density of LMFP in powder form was measured.

### <Measurement of Particle Diameter>

Similarly to Example 1, the median diameters of NCM and LMFP were measured.

### <Nail Penetration Test>

Similarly to Example 1, the surface temperature of the cell after nailing was measured for the fabricated non-aqueous electrolyte secondary battery (cell). The appearance of the cell was also checked one hour after the nailing to see if there was any cleavage outside of the nailing area.

### Example 3-1

The non-aqueous electrolyte secondary battery was fabricated using the positive electrode having the physical properties listed in Table 3 as the positive electrode mixed material layer. The ratio of the half-width of NCM to the half-width of LMFP (hereafter simply referred to as the “ratio value”) (P1/P2) was 0.65. After the nail penetration test, there was no cell cleavage, and the surface temperature was 78° C.

TABLE 3

| | | | | Tapped | | | | Surface | |
|---|---|---|---|---|---|---|---|---|---|
| | | | | density of | D50 of | D50 of | Ratio of | temperature | Cell |
| | P1 | P2 | | LMFP | NCM | LMFP | LMFP | after nailing | cleavage |
| | [degrees] | [degrees] | P1/P2 | [g/cc] | [μm] | [μm] | [%] | [° C.] | Yes/No |
| Example 3-1 | 0.184 | 0.282 | 0.65 | 0.96 | 11.9 | 0.90 | 20 | 78 | No |
| Example 3-2 | 0.274 | 0.282 | 0.97 | 0.96 | 0.90 | 0.90 | 20 | 85 | No |
| Example 3-3 | 0.184 | 0.354 | 0.52 | 0.89 | 11.9 | 0.50 | 20 | 83 | No |
| Example 3-4 | 0.184 | 0.367 | 0.50 | 1.04 | 11.9 | 1.00 | 20 | 99 | Yes |
| Example 3-5 | 0.184 | 0.316 | 0.58 | 0.76 | 11.9 | 0.80 | 20 | 84 | No |
| Example 3-6 | 0.233 | 0.282 | 0.83 | 0.96 | 4.3 | 0.90 | 20 | 110 | Yes |
| Example 3-7 | 0.249 | 0.282 | 0.88 | 0.96 | 4.9 | 0.90 | 20 | 88 | No |
| Example 3-8 | 0.252 | 0.255 | 0.99 | 0.91 | 21.3 | 1.50 | 20 | 123 | Yes |
| Example 3-9 | 0.184 | 0.282 | 0.65 | 0.96 | 11.9 | 0.90 | 30 | 69 | No |
| Example 3-10 | 0.184 | 0.282 | 0.65 | 0.96 | 11.9 | 0.90 | 10 | 92 | No |
| Example 3-11 | 0.184 | 0.282 | 0.65 | 0.96 | 11.9 | 0.90 | 5 | 137 | Yes |
| Example 3-12 | 0.184 | 0.371 | 0.50 | 0.69 | 11.9 | 0.80 | 20 | 87 | No |
| Example 3-13 | 0.223 | 0.354 | 0.63 | 0.89 | 51.4 | 0.50 | 20 | 74 | No |
| Example 3-14 | 0.184 | 0.304 | 0.61 | 1.03 | 11.9 | 2.60 | 20 | 140 | Yes |
| Example 3-15 | 0.250 | 0.255 | 0.98 | 1.10 | 4.3 | 3.60 | 20 | 152 | Yes |
| Comparative | 0.393 | 0.282 | 1.39 | 0.91 | 6.2 | 0.90 | 20 | 486 | Yes |
| Example 3-1 | | | | | | | | | |
| Comparative | 0.184 | 0.178 | 1.03 | 0.93 | 11.9 | 1.00 | 20 | 505 | Yes |
| Example 3-2 | | | | | | | | | |

### Example 3-2

The non-aqueous electrolyte secondary battery was fabricated using the positive electrode having the physical properties listed in Table 3 as the positive electrode mixed material layer. The conditions are the same as those in Example 3-1, except that the half-width P1 is 0.274 degrees and D50 of the NCM is 0.90 μm. The ratio value (P1/P2) was 0.97. After the nail penetration test, there was no cell cleavage, and the surface temperature was 85° C.

### Example 3-3

The non-aqueous electrolyte secondary battery was fabricated using the positive electrode having the physical properties listed in Table 3 as the positive electrode mixed material layer. The conditions are the same as those in Example 3-1, except that the half-width P2 is 0.354 degrees, the tapped density of LMFP is 0.89 g/cc, and D50 of LMFP is 0.50 μm. The ratio value (P1/P2) was 0.52. After the nail penetration test, there was no cell cleavage, and the surface temperature was 83° C.

### Example 3-4

The non-aqueous electrolyte secondary battery was fabricated using the positive electrode having the physical properties listed in Table 3 as the positive electrode mixed material layer. The conditions are the same as those in Example 3-1, except that the half-width P2 is 0.367 degrees, the tapped density of LMFP is 1.04 g/cc, and D50 of LMFP is 1.00 μm. The ratio value (P1/P2) was 0.50. After the nail penetration test, the cell was cleaved, and the surface temperature was 99° C.

### Example 3-5

The non-aqueous electrolyte secondary battery was fabricated using the positive electrode having the physical properties listed in Table 3 as the positive electrode mixed material layer. The conditions are the same as those in Example 3-1, except that the half-width P2 is 0.316 degrees, the tapped density of LMFP is 0.76 g/cc, and D50 of LMFP is 0.80 μm. The ratio value (P1/P2) was 0.58. After the nail penetration test, there was no cell cleavage, and the surface temperature was 84° C.

### Example 3-6

The non-aqueous electrolyte secondary battery was fabricated using the positive electrode having the physical properties listed in Table 3 as the positive electrode mixed material layer. The conditions are the same as those in Example 3-1, except that the half-width P1 is 0.233 degrees and D50 of NCM is 4.3 μm. The ratio value (P1/P2) was 0.83. After the nail penetration test, the cell was cleaved, and the surface temperature was 110° C.

### Example 3-7

The non-aqueous electrolyte secondary battery was fabricated using the positive electrode having the physical properties listed in Table 3 as the positive electrode mixed material layer. The conditions are the same as those in Example 3-1, except that the half-width P1 is 0.249 degrees and D50 of NCM is 4.9 μm. The ratio value (P1/P2) was 0.88. After the nail penetration test, there was no cell cleavage, and the surface temperature was 88° C.

### Example 3-8

The non-aqueous electrolyte secondary battery was fabricated using the positive electrode having the physical properties listed in Table 3 as the positive electrode mixed material layer. The conditions are the same as those in Example 3-1, except that the half-width P1 is 0.252 degrees, the half-width P2 is 0.255 degrees, the tapped density of LMFP is 0.91 g/cc, D50 of NCM is 21.3 μm, and D50 of LMFP is 1.50 μm. The ratio value (P1/P2) was 0.99. After the nail penetration test, the cell was cleaved, and the surface temperature was 123° C.

### Example 3-9

The non-aqueous electrolyte secondary battery was fabricated using the positive electrode having the physical properties listed in Table 3 as the positive electrode mixed material layer. The conditions are the same as those in Example 3-1, except that the percentage of LMFP is 30%. The ratio value (P1/P2) was 0.65. After the nail penetration test, there was no cell cleavage, and the surface temperature was 69° C.

### Example 3-10

The non-aqueous electrolyte secondary battery was fabricated using the positive electrode having the physical properties listed in Table 3 as the positive electrode mixed material layer. The conditions are the same as those in Example 3-1, except that the percentage of LMFP is 10%. The ratio value (P1/P2) was 0.65. After the nail penetration test, there was no cell cleavage, and the surface temperature was 92° C.

### Example 3-11

The non-aqueous electrolyte secondary battery was fabricated using the positive electrode having the physical properties listed in Table 3 as the positive electrode mixed material layer. The conditions are the same as those in Example 3-1, except that the percentage of LMFP is 5%. The ratio value (P1/P2) was 0.65. After the nail penetration test, the cell was cleaved, and the surface temperature was 137° C.

### Example 3-12

The non-aqueous electrolyte secondary battery was fabricated using the positive electrode having the physical properties listed in Table 3 as the positive electrode mixed material layer. The conditions are the same as those in Example 3-1, except that the half-width P2 is 0.371 degrees, the tapped density of LMFP is 0.69 g/cc, and D50 of LMFP is 0.80 μm. The ratio value (P1/P2) was 0.50. After the nail penetration test, there was no cell cleavage, and the surface temperature was 87° C. However, the positive electrode had numerous threading marks, making it unsuitable for continuous production and thus industrially undesirable.

### Example 3-13

The non-aqueous electrolyte secondary battery was fabricated using the positive electrode having the physical properties listed in Table 3 as the positive electrode mixed material layer. The conditions are the same as those in Example 3-1, except that the half-width P1 is 0.223 degrees, the half-width P2 is 0.354 degrees, the tapped density of LMFP is 0.89 g/cc, D50 of NCM is 51.4 μm, and D50 of LMFP is 0.50 μm. The ratio value (P1/P2) was 0.63. After the nail puncture test, there was no cell cleavage, and the surface temperature was 74° C. However, the positive electrode had numerous threading marks, making it unsuitable for continuous production and thus industrially undesirable.

### Example 3-14

The non-aqueous electrolyte secondary battery was fabricated using the positive electrode having the physical properties listed in Table 3 as the positive electrode mixed material layer. The conditions are the same as those in Example 3-1, except that the half-width P2 is 0.304 degrees, the tapped density of LMFP is 1.03 g/cc, and D50 of LMFP is 2.60 μm. The ratio value (P1/P2) was 0.61. After the nail penetration test, the cell was cleaved, and the surface temperature was 140° C.

### Example 3-15

The non-aqueous electrolyte secondary battery was fabricated using the positive electrode having the physical properties listed in Table 3 as the positive electrode mixed material layer. The conditions are the same as those in Example 3-1, except that the half-width P1 is 0.250 degrees, the half-width P2 is 0.255 degrees, the tapped density of LMFP is 1.10 g/cc, D50 of NCM is 4.3 pin, and D50 of LMFP is 3.60 μm. The ratio value (P1/P2) was 0.98. After the nail penetration test, the cell was cleaved, and the surface temperature was 152° C.

### Comparative Example 3-1

The non-aqueous electrolyte secondary battery was fabricated using the positive electrode having the physical properties listed in Table 3 as the positive electrode mixed material layer. The conditions are the same as those in Example 3-1, except that the half-width P1 is 0.393 degrees, the tapped density of LMFP is 0.91 g/cc, and D50 of NCM is 6.2 μm. The ratio value (P1/P2) was 1.39. After the nail penetration test, the cell was cleaved, and the surface temperature was 486° C.

### Comparative Example 3-2

The non-aqueous electrolyte secondary battery was fabricated using the positive electrode having the physical properties listed in Table 3 as the positive electrode mixed material layer. The conditions are the same as those in Example 3-1, except that the half-width P2 is 0.178 degrees, the tapped density of LMFP is 0.93 g/cc, and D50 of LMFP is 1.00 μm. The ratio value (P1/P2) was 1.03. After the nail penetration test, the cell was cleaved, and the surface temperature was 505° C.

When the ratio value (P1/P2) is attempted to make less than 0.30, the crystallite diameter of the second positive electrode active material must be made extremely small, and the material synthesis itself becomes difficult because the crystallinity of the second positive electrode active material tends to become extremely low. Therefore, the ratio value (P1/P2) of less than 0.30 was not carried out.

As can be seen in Table 3, Examples 3-1 to 3-15 showed a surface temperature of 152° C. or lower after nailing. On the other hand, in Comparative Examples 1 and 2, the cells were cleaved, and the surface temperatures were as high as 486° C. or higher. In Comparative Examples 3-1 and 3-2, meltdown of the separator occurred, suggesting that a short circuit occurred inside the cell to cause the successive heat generation. From these results, it can be said that Examples 3-1 to 3-15 have a thermal stability, because the heat generation is suppressed even when an abrupt short circuit occurs. Among them, in Examples 3-1 to 3-3, 3-5, 3-7, 3-9, and 3-10 there was no industrial problem and there was no cell cleavage. Therefore, it can be said that they have an especially excellent thermal stability.

### Example 4

### <Positive Electrode Preparation Method>

The slurry of the positive electrode active material was prepared by mixing 75.2% by weight of LiNi_{0.5}Co_{0.2}Mn_{0.3}O₂ (NCM) as the first positive electrode active material, 18.8% by weight of LiMn_{0.7}Fe_{0.3}PO₄ (LMFP) as the second positive electrode active material, 2% by weight of graphite as the first electrically conductive agent, 3% by weight of acetylene black as the second electrically conductive agent, 1% by weight of polyvinylidene fluoride (PVDF) as the binding agent, and an appropriate amount of N-methyl-2-pyrrolidone (NIP) as the viscosity adjusting solvent.

The resulting slurry of the positive electrode active material was applied to both sides of the positive electrode current collector formed of aluminum foil and having a thickness of 20 μm; then this was dried to form the positive electrode mixed material layer. The coating amount of the positive electrode mixed material layer per one side thereof was made 99 g/m². Next, the positive electrode was pressed to make the density of the positive electrode mixed material layer 2.7 g/cc. The positive electrode mixed material layer was then cut such that the uncoated portion protruded as the positive electrode lead in a rectangular shape from one side of a rectangle of the portion coated with the positive electrode mixed material layer. In the protruding portion, the positive electrode active material layer is not formed, and this functions as the positive electrode lead.

### <Negative Electrode Preparation Method>

The slurry of the negative electrode active material was prepared by mixing 96.7% by weight of graphite as the negative electrode active material, 0.3% by weight of acetylene black as the electrically conductive agent, 1.5% by weight of styrene butadiene rubber as the binding agent, 1.5% by weight of carboxymethyl cellulose as the thickener, and an appropriate amount of ion exchanged water as the viscosity adjusting solvent.

The resulting slurry of the negative electrode active material was applied to both sides of the negative electrode current collector formed of 10 μm thick copper foil; then this was dried to form the negative electrode mixed material layer to obtain the negative electrode. The coating amount of the negative electrode mixed material layer per one side thereof was made 58 g/m². Next, the negative electrode was pressed to make the density of the negative electrode mixed material layer 1.2 g/cc. Then, it was cut such that the uncoated portion protruded rectangularly from one side of the rectangle where the negative electrode mixed material layer was formed. In the protruding portion, the negative electrode mixed material layer is not formed, and this functions as the negative electrode lead.

### Preparation of Non-Aqueous Electrolyte

In the mixture of ethylene carbonate, ethyl methyl carbonate, and dimethyl carbonate with the ratio of 2:5:3 by volume, 1.3 mol/L of LiPF₆ as the lithium salt and 3% by weight of vinylene carbonate as the additive were dissolved, and the resulting solution was used as the non-aqueous electrolyte.

### Preparation of Electrode Element

Next, the electrode element was prepared by alternately stacking the positive electrode having the positive electrode current collection lead and the negative electrode having the negative electrode current collection lead to the sinuously connected separator. The separator having the polypropylene surface layer formed on both sides of polyethylene substrate layer (PE/PP/PE) was used. The thickness of the separator is 20 μm. Next, the positive electrode leads and the negative electrode leads were bundled respectively, and the positive electrode terminal was connected to the bundled positive electrode leads by an ultrasonic welding, and the negative electrode terminal was connected to the bundled negative electrode leads by an ultrasonic welding. The resulting electrode element had a thickness of 3.0 mm and a rated capacity of 4.8 Ah. The “rated capacity” here means the discharge capacity when a constant current/constant voltage charge (cutoff current: 0.05 C) with an upper limit voltage of 4.2 V and a current value of 0.5 C is followed by a constant current discharge with a lower limit voltage of 2.7 V and a current value of 0.2 C.

### Fabrication of Non-Aqueous Electrolyte Secondary Battery

Two sheets of the laminate film were prepared as the outer body, the laminate film having the structure in which a thermally bondable resin layer made of polyolefin, a metal layer made of aluminum foil, and a protective layer made of nylon resin and polyester resin were laminated in this order. The thermally bondable resin layers of the two laminate films were placed to face each other such that the bondable surfaces of the laminate films were overlapped so as to accommodate the electrode group in the two housing recesses. The electrode group was placed such that between the perimeters of the two laminate films, the portion of each terminal where the thermally bondable resin portion was formed passed, and the portion of each terminal was exposed to the outside. In this state, the thermally bondable resin layers were thermally bonded to each other at the perimeters of the laminate films on three sides including the two sides from which each tab of those laminate films extends. Subsequently, the electrolyte solution prepared as described above was charged from one side where the outer body was not thermally bonded. Next, the remaining one side of the outer body was thermally bonded under a reduced pressure environment to obtain the non-aqueous electrolyte secondary battery (cell).

### <Calculation of Specific Surface Area>

The specific surface area of each positive electrode active material was calculated by applying the BET formula to the value measured by the nitrogen adsorption method. The specific surface area of NCM is represented by S1 and that of LMFP is represented by S2.

### <Tapped Density>

The tapped density of LMFP in powder form was measured using the same method as in Example 1.

### <Measurement of Particle Diameter>

Similarly to Example 1, the median diameters of NCM and LMFP were measured.

### <Nail Penetration Test>

Similarly to Example 1, the surface temperature of the cell after nailing was measured for the fabricated non-aqueous electrolyte secondary battery (cell). The appearance of the cell was also checked one hour after the nailing to see if there was any cleavage outside of the nailing area.

### Example 4-1

The non-aqueous electrolyte secondary battery was fabricated using the positive electrode having the physical properties listed in Table 4 as the positive electrode mixed material layer. The value of the ratio of the specific surface areas of NCM and LMFP (hereafter simply referred to as “ratio value”) (S1/S2) was 0.018. After the nail penetration test, there was no cell cleavage, and the surface temperature was 78° C.

TABLE 4

| | | | | Tapped | | | | Surface | |
|---|---|---|---|---|---|---|---|---|---|
| | | | | density | D50 of | D50 of | Ratio of | temperature | Cell |
| | S1 | S2 | | of LMFP | NCM | LMFP | LMFP | after nailing | cleavage |
| | [m²/g] | [m²/g] | S1/S2 | [g/cc] | [μm] | [μm] | [%] | [° C.] | Yes/No |
| Example 4-1 | 0.36 | 20.0 | 0.018 | 0.96 | 11.9 | 0.90 | 20 | 78 | No |
| Example 4-2 | 0.23 | 20.0 | 0.012 | 0.96 | 14.0 | 0.90 | 20 | 69 | No |
| Example 4-3 | 0.36 | 23.8 | 0.015 | 0.78 | 11.9 | 0.80 | 20 | 81 | No |
| Example 4-4 | 0.36 | 18.5 | 0.019 | 1.04 | 11.9 | 1.00 | 20 | 124 | Yes |
| Example 4-5 | 0.39 | 20.0 | 0.020 | 0.90 | 4.9 | 0.90 | 20 | 86 | No |
| Example 4-6 | 0.42 | 20.6 | 0.020 | 0.96 | 4.3 | 0.90 | 20 | 119 | Yes |
| Example 4-7 | 0.36 | 22.3 | 0.016 | 0.91 | 21.3 | 1.50 | 20 | 135 | Yes |
| Example 4-8 | 0.50 | 20.0 | 0.025 | 0.96 | 8.1 | 0.90 | 20 | 106 | No |
| Example 4-9 | 0.13 | 23.8 | 0.005 | 0.78 | 18.3 | 0.80 | 20 | 103 | No |
| Example 4-10 | 0.36 | 25.6 | 0.014 | 0.79 | 11.9 | 0.50 | 20 | 86 | No |
| Example 4-11 | 0.36 | 20.0 | 0.018 | 0.96 | 11.9 | 0.90 | 5 | 136 | Yes |
| Example 4-12 | 0.36 | 20.0 | 0.018 | 0.96 | 11.9 | 0.90 | 10 | 107 | No |
| Example 4-13 | 0.36 | 20.0 | 0.018 | 0.96 | 11.9 | 0.90 | 30 | 69 | No |
| Example 4-14 | 0.23 | 24.5 | 0.009 | 1.02 | 14.0 | 5.20 | 20 | 151 | Yes |
| Example 4-15 | 0.23 | 22.7 | 0.010 | 1.05 | 14.0 | 4.80 | 20 | 146 | Yes |
| Example 4-16 | 0.23 | 16.2 | 0.014 | 1.06 | 14.0 | 3.70 | 20 | 139 | Yes |
| Example 4-17 | 0.23 | 12.4 | 0.019 | 1.09 | 14.0 | 3.20 | 20 | 143 | Yes |
| Example 4-18 | 0.23 | 11.2 | 0.021 | 1.11 | 14.0 | 2.90 | 20 | 152 | Yes |
| Example 4-19 | 0.36 | 25.2 | 0.014 | 0.69 | 11.9 | 0.80 | 20 | 87 | No |
| Example 4-20 | 0.21 | 25.6 | 0.008 | 0.79 | 51.4 | 0.50 | 20 | 75 | No |
| Comparative | 0.57 | 20.0 | 0.029 | 0.96 | 6.2 | 0.90 | 20 | 522 | Yes |
| Example 4-1 | | | | | | | | | |
| Comparative | 0.36 | 13.5 | 0.027 | 1.08 | 11.9 | 1.10 | 20 | 451 | Yes |
| Example 4-2 | | | | | | | | | |
| Comparative | 0.13 | 30.1 | 0.004 | 1.04 | 18.3 | 2.40 | 20 | 498 | Yes |
| Example 4-3 | | | | | | | | | |

### Example 4-2

The non-aqueous electrolyte secondary battery was fabricated using the positive electrode having the physical properties listed in Table 4 as the positive electrode mixed material layer. The conditions are the same as those in Example 4-1, except that the specific surface area S1 is 0.23 ma/g and D50 of NCM is 14.0 μm. The ratio value (S1/S2) was 0.012. After the nail penetration test, there was no cell cleavage, and the surface temperature was 69° C.

### Example 4-3

The non-aqueous electrolyte secondary battery was fabricated using the positive electrode having the physical properties listed in Table 4 as the positive electrode mixed material layer. The conditions are the same as those in Example 4-1, except that the specific surface area S2 is 23.80 m²/g, the tapped density of LMFP is 0.78 g/cc, and D50 of LMFP is 0.80 μm. The ratio value (S1/S2) was 0.015. After the nail penetration test, there was no cell cleavage, and the surface temperature was 81° C.

### Example 4-4

The non-aqueous electrolyte secondary battery was fabricated using the positive electrode having the physical properties listed in Table 4 as the positive electrode mixed material layer. The conditions are the same as those in Example 4-1, except that the specific surface area S2 is 18.5 m²/g, the tapped density of LMFP is 1.04 g/cc, and D50 of LMFP is 1.00 μm. The ratio value (S1/S2) was 0.019. After the nail penetration test, the cell was cleaved, and the surface temperature was 124° C.

### Example 4-5

The non-aqueous electrolyte secondary battery was fabricated using the positive electrode having the physical properties listed in Table 4 as the positive electrode mixed material layer. The conditions are the same as those in Example 4-1, except that the specific surface area S1 is 0.39 m²/g, the tapped density of LMFP is 0.90 g/cc, and D50 of NCM is 4.9 μm. The ratio value (S1/S2) was 0.020. After the nail penetration test, there was no cell cleavage, and the surface temperature was 86° C.

### Example 4-6

The non-aqueous electrolyte secondary battery was fabricated using the positive electrode having the physical properties listed in Table 4 as the positive electrode mixed material layer. The conditions are the same as those in Example 4-1, except that the specific surface area S1 is 0.42 m²/g, the specific surface area S2 is 20.6 m²/g, and D50 of NCM is 4.3 μm. The ratio value (S1/S2) was 0.020. After the nail penetration test, the cell was cleaved, and the surface temperature was 119° C.

### Example 4-7

The non-aqueous electrolyte secondary battery was fabricated using the positive electrode having the physical properties listed in Table 1 as the positive electrode mixed material layer. The conditions are the same as those in Example 1, except that the specific surface area S2 is 22.3 m²/g, the tapped density of LMFP is 0.91 g/cc, D50 of NCM is 21.3 μm, and D50 of LMFP is 1.50 μm. The ratio value (S1/S2) was 0.016. After the nail penetration test, the cell was cleaved, and the surface temperature was 135° C.

### Example 4-8

The non-aqueous electrolyte secondary battery was fabricated using the positive electrode having the physical properties listed in Table 4 as the positive electrode mixed material layer. The conditions are the same as those in Example 4-1, except that the specific surface area S1 is 0.50 m²/g and D50 of NCM is 8.1 μm. The ratio of specific surface areas (S1/S2) of NCM and LMFP was 0.025. After the nail penetration test, there was no cell cleavage, and the surface temperature was 106° C.

### Example 4-9

The non-aqueous electrolyte secondary battery was fabricated using the positive electrode having the physical properties listed in Table 4 as the positive electrode mixed material layer. The conditions are the same as those in Example 4-1, except that the specific surface area S1 is 0.13 m²/g, the specific surface area S2 is 23.8 m²/g, the tapped density of LMFP is 0.78 g/cc, D50 of NCM is 18.3 μm, and D50 of LMFP is 0.80 μm. The ratio of specific surface areas (S1/S2) of NCM and LMFP was 0.005. After the nail penetration test, there was no cell cleavage, and the surface temperature was 103° C.

### Example 4-10

The non-aqueous electrolyte secondary battery was fabricated using the positive electrode having the physical properties listed in Table 4 as the positive electrode mixed material layer. The conditions are the same as those in Example 4-1, except that the specific surface area S2 is 25.6 m²/g, the tapped density of LMFP is 0.79 g/cc, and D50 of LMFP is 0.50 μm. The ratio of specific surface areas (S1/S2) of NCM and LMFP was 0.014. After the nail penetration test, there was no cell cleavage, and the surface temperature was 86° C.

### Example 4-11

The non-aqueous electrolyte secondary battery was fabricated using the positive electrode having the physical properties listed in Table 4 as the positive electrode mixed material layer. The conditions are the same as those in Example 4-1, except that the percentage of LMFP is 5%. The ratio of specific surface areas (S1/S2) of NCM and LMFP was 0.018. After the nail penetration test, there was no cell cleavage, and the surface temperature was 136° C.

### Example 4-12

The non-aqueous electrolyte secondary battery was fabricated using the positive electrode having the physical properties listed in Table 4 as the positive electrode mixed material layer. The conditions are the same as those in Example 4-1, except that the percentage of LMFP is 10%. The ratio of specific surface areas (S1/S2) of NCM and LMFP was 0.018. After the nail penetration test, there was no cell cleavage, and the surface temperature was 107° C.

### Example 4-13

The non-aqueous electrolyte secondary battery was fabricated using the positive electrode having the physical properties listed in Table 4 as the positive electrode mixed material layer. The conditions are the same as those in Example 4-1, except that the percentage of LMFP is 30%. The ratio of specific surface areas (S1/S2) of NCM and LMFP was 0.018. After the nail penetration test, there was no cell cleavage, and the surface temperature was 69° C.

### Example 4-14

The non-aqueous electrolyte secondary battery was fabricated using the positive electrode having the physical properties listed in Table 4 as the positive electrode mixed material layer. The conditions are the same as those in Example 4-1, except that the specific surface area S1 is 0.23 m²/g, the specific surface area S2 is 24.5 m²/g, the tapped density of LMFP is 1.02 g/cc, D50 of NCM is 14.0 μm, and D50 of LMFP is 5.20 μm. The ratio of specific surface areas (S1/S2) of NCM and LMFP was 0.009. After the nail penetration test, the cell was cleaved, and the surface temperature was 151° C.

### Example 4-15

The non-aqueous electrolyte secondary battery was fabricated using the positive electrode having the physical properties listed in Table 4 as the positive electrode mixed material layer. The conditions are the same as those in Example 4-1, except that the specific surface area S1 is 0.23 ma/g, the specific surface area S2 is 22.7 m²/g, the tapped density of LMFP is 1.05 g/cc, D50 of NCM is 14.0 μm, and D50 of LMFP is 4.80 μm. The ratio of specific surface areas (S1/S2) of NCM and LMFP was 0.010. After the nail penetration test, the cell was cleaved, and the surface temperature was 146° C.

### Example 4-16

The non-aqueous electrolyte secondary battery was fabricated using the positive electrode having the physical properties listed in Table 4 as the positive electrode mixed material layer. The conditions are the same as those in Example 4-1, except that the specific surface area S1 is 0.23 m²/g, the specific surface area S2 is 16.2 m²/g, the tapped density of LMFP is 1.06 g/cc, D50 of NCM is 14.0 μm, and D50 of LMFP is 3.70 μm. The ratio of specific surface areas (S1/S2) of NCM and LMFP was 0.014. After the nail penetration test, the cell was cleaved, and the surface temperature was 139° C.

### Example 4-17

The non-aqueous electrolyte secondary battery was fabricated using the positive electrode having the physical properties listed in Table 4 as the positive electrode mixed material layer. The conditions are the same as those in Example 4-1, except that the specific surface area S1 is 0.23 m²/g, the specific surface area S2 is 12.4 m²/g, the tapped density of LMFP is 1.09 g/cc, D50 of NCM is 14.0 μm, and D50 of LMFP is 3.20 μm. The ratio of specific surface areas (S1/S2) of NCM and LMFP was 0.019. After the nail penetration test, the cell was cleaved, and the surface temperature was 143° C.

### Example 4-18

The non-aqueous electrolyte secondary battery was fabricated using the positive electrode having the physical properties listed in Table 4 as the positive electrode mixed material layer. The conditions are the same as those in Example 4-1, except that the specific surface area S1 is 0.23 m²/g, the specific surface area S2 is 11.2 m²/g, the tapped density of LMFP is 1.11 g/cc, D50 of NCM is 14.0 μm, and D50 of LMFP is 2.90 μm. The ratio of specific surface areas (S1/S2) of NCM and LMFP was 0.021. After the nail penetration test, the cell was cleaved, and the surface temperature was 152° C.

### Example 4-19

The non-aqueous electrolyte secondary battery was fabricated using the positive electrode having the physical properties listed in Table 4 as the positive electrode mixed material layer. The conditions are the same as those in Example 4-1, except that the specific surface area S2 is 25.2 m²/g, the tapped density of LMFP is 0.69 g/cc, and D50 of LMFP is 0.80 μm. The ratio of specific surface areas (S1/S2) of NCM and LMFP was 0.014. After the nail penetration test, there was no cell cleavage, and the surface temperature was 87° C. However, the positive electrode had numerous threading marks, making it unsuitable for continuous production and thus industrially undesirable.

### Example 4-20

The non-aqueous electrolyte secondary battery was fabricated using the positive electrode having the physical properties listed in Table 4 as the positive electrode mixed material layer. The conditions are the same as those in Example 4-1, except that the specific surface area S1 is 0.21 m²/g, the specific surface area S2 is 25.6 m²/g, the tapped density of LMFP is 0.79 g/cc, D50 of NCM is 51.4 μm, and D50 of LMFP is 0.50 μm. The ratio of specific surface areas (S1/S2) of NCM and LMFP was 0.008. After the nail penetration test, there was no cell cleavage, and the surface temperature was 75° C. However, the positive electrode had numerous threading marks, making it unsuitable for continuous production and thus industrially undesirable.

### Comparative Example 4-1

The non-aqueous electrolyte secondary battery was fabricated using the positive electrode having the physical properties listed in Table 4 as the positive electrode mixed material layer. The conditions are the same as those in Example 4-1, except that the specific surface area S1 is 0.57 m²/g and D50 of NCM is 6.2 μm. The ratio value (S1/S2) was 0.029. After the nail penetration test, the cell was cleaved, and the surface temperature was 522° C.

### Comparative Example 4-2

The non-aqueous electrolyte secondary battery was fabricated using the positive electrode having the physical properties listed in Table 4 as the positive electrode mixed material layer. The conditions are the same as those in Example 4-1, except that the specific surface area S2 is 13.5 m²/g, the tapped density of LMFP is 1.08 g/cc, and D50 of LMFP is 1.10 μm. The ratio value (S1/S2) was 0.027. After the nail penetration test, the cell was cleaved, and the surface temperature was 451° C.

### Comparative Example 4-3

The non-aqueous electrolyte secondary battery was fabricated using the positive electrode having the physical properties listed in Table 4 as the positive electrode mixed material layer. The conditions are the same as those in Example 4-1, except that the specific surface area S1 is 0.13 m²/g, the specific surface area S2 is 30.1 m²/g, D50 of NCM is 18.3 μm, the tapped density of LMFP is 1.04 g/cc, and D50 of LMFP is 2.40 μm. The ratio value (S1/S2) was 0.004. After the nail penetration test, the cell was cleaved, and the surface temperature was 498° C.

As can be seen in Table 4, Examples 4-1 to 4-20 showed a surface temperature of 152° C. or lower. On the other hand, in Comparative Examples 4-1 to 4-3, the cell was cleaved, and the surface temperature was as high as 451° C. or higher. In Comparative Examples 4-1 to 4-3, meltdown of the separator occurred, suggesting that a short circuit occurred inside the cell to cause the successive heat generation. From these results, it can be said that Examples 4-1 to 4-20 have a thermal stability, because the heat generation is suppressed even when an abrupt short circuit occurs. Among them, Examples 4-1 to 4-3, 4-5, 4-8 to 4-10, 4-12, and 4-13 showed no industrial problem nor cell cleavage; thus it can be said that they have an especially excellent thermal stability.

### INDUSTRIAL APPLICABILITY

As described above, the positive electrode for non-aqueous electrolyte secondary battery and the non-aqueous electrolyte secondary battery according to the present invention are useful for suppressing the heat generation even when an abrupt short circuit occurs.

### REFERENCE SIGNS LIST

1, 1A Non-aqueous electrolyte secondary battery
2 Outer body
3 Electrode group
4, 118 Positive electrode
5, 115 Negative electrode
6, 114 Separator
7 Positive electrode lead
8 Positive electrode tab
9 Negative electrode lead
10 Negative electrode tab
41, 112 Positive electrode current collector
42, 113 Positive electrode mixed material layer
51 Negative electrode current collector
52 Negative electrode mixed material layer
110 Case
111 Plate spring
116 Gasket
117 Cap

1. A positive electrode, comprising:
a positive electrode current collector; and
a positive electrode mixed material layer formed on a surface of the positive electrode current collector,
wherein the positive electrode mixed material layer comprises:
a first positive electrode active material that is a layered compound represented by formula (1),
LiₐNiₓCo_{y}M1_{1-x-y}O₂ (1);
a second positive electrode active material having a carbon material film formed on a surface of a phosphate compound that is represented by formula (2) and that has an olivine structure,
LiMn_{z}M2_{b}Fe_{1-z-b}PO₄ (2); and
an electrically conductive agent,
a median diameter of the first positive electrode active material is larger than D90 of the second positive electrode active material,
in the formula (1), M1 is at least one element selected from the group consisting of Ti, Zr, Nb, W, P, Al, Mg, V, Mn, Ca, Sr, Cr, Fe, B, Ga, In, Si, Mo, Y, Sn, Cu, Ag, Ce, Pr, Ge, Bi, Ba, Er, La, Sm, Yb, Sb, Bi, S and Zn, and
in the formula (2), M2 is at least one element selected from the group consisting of Ni, Co, Ti, Cu, Zn, Mg, Zr, Ca, Y, Mo, Ba, Pb, Bi, La, Ce, Nd, Gd, Al, Ga and Sr.

2. The positive electrode according to claim 1, wherein the second positive electrode active material has a tapped density of 0.70 g/cc or more and 1.00 g/cc or less.

3. The positive electrode according to claim 1, wherein a median diameter of the second positive electrode active material is 1/100 or more and ⅕ or less of the median diameter of the first positive electrode active material.

4. The positive electrode according to claim 1, wherein a median diameter of the second positive electrode active material is 0.1 μm or more and 1.0 μm or less.

5. The positive electrode according to claim 1, wherein, a ratio of a weight of the second positive electrode active material to a total weight of the first positive electrode active material and the second positive electrode active material is 10% or more and 30% or less.

6. The positive electrode according to claim 1, wherein:
when a tapped density (g/cc) of the first positive electrode active material is represented by W1, a tapped density (g/cc) of the second positive electrode active material is represented by W2, a ratio of a weight of the first positive electrode active material to a total weight of the first positive electrode active material and the second positive electrode active material, upon considering the total weight as 1, is represented by R1, a ratio of a weight of the second positive electrode active material to the total weight of the first positive electrode active material and the second positive electrode active material, upon considering the total weight as 1, is represented by R2, and a density (g/cc) of the positive electrode mixed material layer calculated based on a thickness of the positive electrode for a non-aqueous electrolyte secondary battery when a charging rate of the non-aqueous electrolyte secondary battery after initial activation is 0% is represented by D, formula (3) is satisfied,
0.760≤(W1×R1+W2×R2)/D≤0.960 (3).

7. The positive electrode according to claim 6, wherein the weight ratio R2 is 0.1 or more and 0.3 or less.

8. The positive electrode according to claim 1, wherein a ratio of a specific surface area of the first positive electrode active material to a specific surface area of the second positive electrode active material is 0.005 or more and 0.025 or less.

9. A non-aqueous electrolyte secondary battery comprising:
the positive electrode according to claim 1;
a negative electrode;
a separator; and
a non-aqueous electrolyte comprising a lithium salt and a non-aqueous solvent.

10. A non-aqueous electrolyte secondary battery comprising:
the positive electrode according to claim 2;
a negative electrode;
a separator; and
a non-aqueous electrolyte comprising a lithium salt and a non-aqueous solvent.

11. A non-aqueous electrolyte secondary battery comprising:
the positive electrode according to claim 3;
a negative electrode;
a separator; and
a non-aqueous electrolyte comprising a lithium salt and a non-aqueous solvent.

12. A non-aqueous electrolyte secondary battery comprising:
the positive electrode according to claim 4;
a negative electrode;
a separator; and
a non-aqueous electrolyte comprising a lithium salt and a non-aqueous solvent.

13. A non-aqueous electrolyte secondary battery comprising:
the positive electrode according to claim 5;
a negative electrode;
a separator; and
a non-aqueous electrolyte comprising a lithium salt and a non-aqueous solvent.

14. A non-aqueous electrolyte secondary battery comprising:
the positive electrode according to claim 6;
a negative electrode;
a separator; and
a non-aqueous electrolyte comprising a lithium salt and a non-aqueous solvent.

15. A non-aqueous electrolyte secondary battery comprising:
the positive electrode according to claim 7;
a negative electrode;
a separator; and
a non-aqueous electrolyte comprising a lithium salt and a non-aqueous solvent.

16. A non-aqueous electrolyte secondary battery comprising:
the positive electrode according to claim 8;
a negative electrode;
a separator; and
a non-aqueous electrolyte comprising a lithium salt and a non-aqueous solvent.
